(19) United States
(12) Patent Application Publication
(10) Pub. No.: US 2017/0182665 A1
(43) Pub. Date: Jun. 29, 2017

(54) ROBOT, ROBOT CONTROL DEVICE, AND ROBOT SYSTEM

(71) Applicant: Seiko Epson Corporation, Tokyo (JP)

(72) Inventors: Masayuki OKUYAMA, Suwa (JP); Makoto KOBAYASHI, Matsumoto (JP); Masato YOKOTA, Matsumoto (JP)

(21) Appl. No.: 15/391,137

(22) Filed: Dec. 27, 2016

(30) Foreign Application Priority Data
Dec. 28, 2015 (JP) 2015-255908
Dec. 28, 2015 (JP) 2015-255909
Dec. 28, 2015 (JP) 2015-255910

(51) Int. Cl. B25J 9/16

(52) U.S. Cl. CPC B25J 9/1697; Y10S 901/47

(57) ABSTRACT

A robot moves a first target object in a second direction different from a first direction based on an image captured by an imaging device from a time when the imaging device images the first target object at a first position until a time when the first target object reaches a second position which is in the same first direction as the first position.

### BACKGROUND

1. Technical Field

The present invention relates to a robot, a robot control device, and a robot system.

2. Related Art

Research and development on a control device that causes a robot to perform a work based on an image captured by an imaging device are underway.

In this regard, a robot controller that specifies a work position and posture based on an image captured by a camera to control a robot under a robot system including the camera and the robot is known (for example, refer to JP-A-2012-166314).

In addition, research and development on a robot that performs a work of discharging a liquid to the target object by means of a tool discharging the liquid, such as a dispenser, are underway.

In this regard, an XY robot of which a rotation-control-type adhesive dispenser is disposed in a vertical direction is known (for example, refer to JP-A-2001-300387).

Furthermore, research and development on a control device that causes a robot to perform a work based on an image captured by an imaging unit are underway.

In this regard, a robot controller that specifies work position and posture information with a robot arm as a reference to control the robot arm based on an image captured by a camera under a robot system including one camera and one robot arm is known (for example, JP-A-2014-180722).

However, in the robot controller of JP-A-2012-166314, in a case where an operating shaft that moves the work in a first direction is tilted, the work position is shifted in a second direction different from the first direction in some cases in response to a movement in the first direction once the work is moved to a transporting destination different from a position in the first direction based on the image captured by the imaging device.

In addition, in the robot of JP-A-2001-300387, in a case where the dispenser runs out of the liquid discharged by the dispenser or in a case where the dispenser is damaged, a relative position between a position of a tool center point (TCP) of the robot and a position of a tip portion of the dispenser is shifted in some cases once the dispenser is exchanged. For this reason, in this robot, it is difficult to improve the accuracy of the work of discharging the liquid from the dispenser to the target object in some cases.

Furthermore, in the robot controller of JP-A-2014-180722, it is difficult to control two or more robot arms based on the image captured by one camera unless mechanical calibration is carried out between the robot arms. In addition, the mechanical calibration between the robot arms requires time and effort and it is difficult to achieve an intended accuracy of the calibration. Herein, the mechanical calibration is adjusting a relative position and posture of a plurality of robot arms by each of positions at which the plurality of robot arms are provided being adjusted (changed).

### SUMMARY

An advantage of some aspects of the invention is to solve at least a part of the problems described above, and the invention can be implemented as the following forms or application examples.

An aspect of the invention is directed to a robot that moves a first target object in a second direction different from a first direction based on an image captured by an imaging device from a time when the imaging device images the first target object at a first position until a time when the first target object reaches a second position which is in the same first direction as the first position.

In this configuration, the robot moves the first target object in the second direction different from the first direction based on the image captured by the imaging device from the time when the imaging device images the first target object at the first position until the time when the first target object reaches the second position which is in the same first direction as in the first position. Accordingly, the robot can make the position in the first direction at the time of imaging the first target object identical to the position in the first direction at the time of reaching the second position. As a result, the robot can restrict the position of the first target object from being shifted in the second direction in response to the movement of the first target object in the first direction.

In another aspect of the invention, the robot may be configured such that the first target object is moved by a movement unit that is capable of moving the first target object in the first direction and the second direction.

In this configuration, the robot moves the first target object by means of the movement unit that is capable of moving the first target object in the first direction and the second direction. Accordingly, the robot can restrict the position of the first target object from being shifted in the second direction in response to the movement of the first target object in the first direction caused by the movement unit.

In another aspect of the invention, the robot may be configured such that the movement unit includes a first arm which is supported by a support base and is capable of rotating about a first axis, a second arm which is supported by the first arm and is capable of rotating about a second axis, and an operating shaft which is supported by the second arm and is capable of moving in the first direction and rotating about a third axis.

In this configuration, the robot moves the first target object in the first direction and the second direction by means of the first arm, the second arm, and the operating shaft. Accordingly, the robot can restrict the position of the first target object from being shifted in the second direction in response to the movement of the first target object in the first direction caused by the first arm, the second arm, and the operating shaft.

In another aspect of the invention, the robot may be configured such that the angle of rotation of the operating shaft about the third axis at the time of imaging is made the same as the angle of rotation of the operating shaft about the third axis at the time of reaching.

In this configuration, the robot makes the angle of rotation of the operating shaft about the third axis at the time when the imaging device images the first target object at the first position the same as the angle of rotation of the operating shaft about the third axis at the time when the first target object reaches the second position. Accordingly, the robot can restrict the position of the first target object from being shifted in the second direction in response to the rotation about the third axis.

In another aspect of the invention, the robot may be configured such that the first target object is brought into contact with a second target object at the second position.

In this configuration, the robot brings the first target object into contact with the second target object at the second position. Accordingly, the robot can restrict the position of the first target object from being shifted in the second direction in response to the movement of the first target object in the first direction in the work of bringing the first target object into contact with the second target object.

In another aspect of the invention, the robot may be configured such that the first target object is fitted to the second target object at the second position.

In this configuration, the robot fits the first target object in the second target object at the second position. Accordingly, the robot can restrict the position of the first target object from being shifted in the second direction in response to the movement of the first target object in the first direction in the work of fitting the first target object in the second target object.

Another aspect of the invention is directed to a robot control device that controls the robot according to any one of the aspects.

In this configuration, the robot control device moves the first target object in the second direction different from the first direction based on the image captured by the imaging device from the time when the imaging device images the first target object at a first position until the time when the first target object reaches the second position which is in the same first direction as the first position. Accordingly, the robot control device can make the position in the first direction at the time of imaging the first target object identical to the position in the first direction at the time of reaching the second position. As a result, the robot control device can restrict the first target object from being shifted in the second direction in response to the movement of the first target object in the first direction.

Another aspect of the invention is directed to a robot system that includes the robot according to any one of the aspects, the robot control device, and the imaging device.

In this configuration, the robot system moves the first target object in the second direction different from the first direction based on the image captured by the imaging device from the time when the imaging device images the first target object at the first position until the time when the first target object reaches the second position which is in the same first direction as the first position. Accordingly, the robot system can make the position in the first direction at the time of imaging the first target object identical to the position in the first direction at the time of reaching the second position. As a result, the robot system can restrict the position of the first target object from being shifted in the second direction in response to the movement of the first target object in the first direction.

As described above, the robot, the robot control device, and the robot system move the first target object in the second direction different from the first direction based on the image captured by the imaging device from the time when the imaging device images the first target object at the first position until the time when the first target object reaches the second position which is in the same first direction as the first position. Accordingly, the robot, the robot control device, and the robot system can restrict the position of the first target object from being shifted in the second direction in response to the movement of the first target object in the first direction.

Another aspect of the invention is directed to a robot that includes a movement unit which moves a discharging unit discharging a liquid, that detects a position of the discharging unit by means of a position detector, and that moves the discharging unit by means of the movement unit based on the detected result.

In this configuration, the robot detects the position of the discharging unit by means of the position detector, and moves the discharging unit by means of the movement unit based on the detected result. Accordingly, the robot can perform a work of discharging the liquid to the target object with high accuracy even in a case where the position of the discharging unit is shifted.

In another aspect of the invention, the robot may be configured such that the discharging unit is capable of being attached and detached with respect to the movement unit.

In this configuration, the robot detects the position of the discharging unit which is capable of being attached and detached with respect to the movement unit by means of the position detector, and moves the discharging unit by means of the movement unit based on the detected result. Accordingly, the robot can perform the work of discharging the liquid to the target object with high accuracy even in a case where the position of the discharging unit which is capable of being attached and detached with respect to the movement unit is shifted.

In another aspect of the invention, the robot may be configured such that the position detector is a contact sensor.

In this configuration, the robot detects the position of the discharging unit by means of the contact sensor, and moves the discharging unit by means of the movement unit based on the detected result. Accordingly, the robot can perform the work of discharging the liquid to the target object with high accuracy based on the position of the discharging unit, which is the position detected by the contact sensor, even in a case where the position of the discharging unit is shifted.

In another aspect of the invention, the robot may be configured such that the position detector is a laser sensor.

In this configuration, the robot detects the position of the discharging unit by means of the laser sensor, and moves the discharging unit by means of the movement unit based on the detected result. Accordingly, the robot can perform the work of discharging the liquid to the target object with high accuracy based on the position of the discharging unit, which is the position detected by the laser sensor, even in a case where the position of the discharging unit is shifted.

In another aspect of the invention, the robot may be configured such that the position detector is a force sensor.

In this configuration, the robot detects the position of the discharging unit by means of the force sensor, and moves the discharging unit by means of the movement unit based on the detected result. Accordingly, the robot can perform the work of discharging the liquid to the target object with high accuracy based on the position of the discharging unit, which is the position detected by the force sensor, even in a case where the position of the discharging unit is shifted.

In another aspect of the invention, the robot may be configured such that the position detector is an imaging unit.

In this configuration, the robot detects the position of the discharging unit by means of the imaging unit, and moves the discharging unit by means of the movement unit based on the detected result. Accordingly, the robot can perform the work of discharging the liquid to the target object with high accuracy based on the position of the discharging unit, which is the position detected by the imaging unit, even in a case where the position of the discharging unit is shifted.

In another aspect of the invention, the robot may be configured such that the movement unit moves the discharging unit based on a first image of the liquid discharged by the discharging unit captured by the imaging unit.

In this configuration, the robot moves the discharging unit by means of the movement unit based on the first image of the liquid discharged by the discharging unit captured by the imaging unit. Accordingly, the robot can perform the work of discharging the liquid to the target object with high accuracy based on the first image even in a case where the position of the discharging unit is shifted.

In another aspect of the invention, the robot may be configured such that the movement unit moves the discharging unit based on the position of the liquid included in the first image.

In this configuration, the robot moves the discharging unit by means of the movement unit based on the position of liquid included in the first image. Accordingly, the robot can perform the work of discharging the liquid to the target object with high accuracy based on the position of liquid included in the first image even in a case where the position of the discharging unit is shifted.

In another aspect of the invention, the robot may be configured such that one or more trial discharging points, which are positions of the liquid, are included in the first image and the movement unit moves the discharging unit based on one or more trial discharging points included in the first image.

In this configuration, the robot moves the discharging unit by means of the movement unit based on one or more trial discharging points included in the first image. Accordingly, the robot can perform the work of discharging the liquid to the target object with high accuracy based on one or more trial discharging points included in the first image even in a case where the position of the discharging unit is shifted.

In another aspect of the invention, the robot may be configured such that a marker is provided on a discharging target to which the liquid is discharged and the movement unit moves the discharging unit based on a second image of the marker captured by the imaging unit.

In this configuration, in the robot, the marker is provided in the discharging target to which the liquid is discharged and the discharging unit is moved by the movement unit based on the second image of the marker captured by the imaging unit. Accordingly, the robot can perform the work of discharging the liquid to the target object with high accuracy based on the first image and the second image even in a case where the position of the discharging unit is shifted.

In another aspect of the invention, the robot may be configured such that the discharging unit is moved by the movement unit based on the position of the marker included in the second image.

In this configuration, the robot moves the discharging unit by means of the movement unit based on the position of the marker included in the second image. Accordingly, the robot can perform the work of discharging the liquid to the target object with high accuracy based on the position of the marker included in the first image and the second image even in a case where the position of the discharging unit is shifted.

In another aspect of the invention, the robot may be configured such that the imaging unit is provided in the movement unit.

In this configuration, the robot detects the position of the discharging unit by means of the imaging unit provided in the movement unit, and moves the discharging unit by means of the movement unit based on the detected result. Accordingly, the robot can perform the work of discharging the liquid to the target object with high accuracy based on the position of the discharging unit, which is the position detected by the imaging unit provided in the movement unit, even in a case where the position of the discharging unit is shifted.

In another aspect of the invention, the robot may be configured such that the liquid is an adhesive.

In this configuration, the robot detects the position of the discharging unit which discharges the adhesive by means of the position detector, and moves the discharging unit by means of the movement unit based on the detected result. Accordingly, the robot can perform the work of discharging the adhesive to the target object with high accuracy even in a case where the position of the discharging unit is shifted.

Another aspect of the invention is directed to a robot control device that controls the robot according to any one of the aspects.

In this configuration, the robot control device detects the position of the discharging unit by means of the position detector, and moves the discharging unit by means of the movement unit based on the detected result. Accordingly, the robot control device can perform the work of discharging the liquid to the target object with high accuracy even in a case where the position of the discharging unit is shifted.

Another aspect of the invention is directed to a robot system that includes the robot according to any one of the aspects and the robot control device which controls the robot.

In this configuration, the robot system detects the position of the discharging unit by means of the position detector, and moves the discharging unit by means of the movement unit based on the detected result. Accordingly, the robot system can perform the work of discharging the liquid to the target object with high accuracy even in a case where the position of the discharging unit is shifted.

As described above, the robot, the robot control device, and the robot system detect the position of the discharging unit by means of the position detector, and move the discharging unit by means of the movement unit based on the detected result. Accordingly, the robot, the robot control device, and the robot system can perform the work of discharging the liquid to the target object with high accuracy even in a case where the position of the discharging unit is shifted.

Another aspect of the invention is directed to a control device that operates a first robot based on the first image captured by an imaging unit and a first robot coordinate system, and operates a second robot based on a second robot coordinate system different from the first robot coordinate system and the second image captured by the imaging unit.

In this configuration, the control device operates the first robot based on the first image captured by the imaging unit and the first robot coordinate system, and operates the second robot based on the second robot coordinate system different from the first robot coordinate system and the second image captured by the imaging unit. Accordingly, the control device can operate the first robot and the second robot with high accuracy based on an image captured by one imaging unit without mechanical calibration being carried out.

In another aspect of the invention, the control device may be configured such that the first image and the second image are the same image.

In this configuration, the control device operates the first robot based on the first image captured by the imaging unit and the first robot coordinate system, and operates the second robot based on the second robot coordinate system and the first image. Accordingly, the control device can easily operate the first robot and the second robot based on the first image captured by one imaging unit without mechanical calibration being carried out.

In another aspect of the invention, the control device may be configured such that the imaging unit is provided in the first robot.

In this configuration, the control device operates the first robot based on the first image captured by the imaging unit provided in the first robot and the first robot coordinate system, and operates the second robot based on the second robot coordinate system and the second image captured by the imaging unit. Accordingly, the control device can easily operate the first robot and the second robot based on the image captured by the imaging unit provided in the first robot without mechanical calibration being carried out.

In another aspect of the invention, the control device may be configured such that the first robot coordinate system and the imaging unit coordinate system of the imaging unit are correlated with each other, and the second robot coordinate system and the imaging unit coordinate system are correlated with each other, by the imaging unit being moved.

In this configuration, the control device correlates the first robot coordinate system with the imaging unit coordinate system of the imaging unit, and correlates the second robot coordinate system with the imaging unit coordinate system, by moving the imaging unit. Accordingly, the control device can operate the first robot with high accuracy based on the first image and the first robot coordinate system, and can operate the second robot with high accuracy based on the second image and the second robot coordinate system.

In another aspect of the invention, the control device may be configured such that the first robot coordinate system and the imaging unit coordinate system of the imaging unit are correlated with each other by the imaging unit being moved.

In this configuration, the control device correlates the first robot coordinate system with the imaging unit coordinate system of the imaging unit by moving the imaging unit. Accordingly, the control device can operate the first robot with high accuracy based on the first image and the first robot coordinate system.

In another aspect of the invention, the control device may be configured such that the second robot coordinate system and the imaging unit coordinate system are correlated with each other by the imaging unit being fixed and the target object being moved by the second robot.

In this configuration, the control device correlates the second robot coordinate system with the imaging unit coordinate system by fixing the imaging unit and moving the target object by means of the second robot. Accordingly, the control device can operate the second robot with high accuracy based on the second image and the second robot coordinate system.

Another aspect of the invention is directed to a robot system that includes the first robot, the second robot, and the control device according to any one of the aspects.

In this configuration, the robot system operates the first robot based on the first image captured by the imaging unit and the first robot coordinate system, and operates the second robot based on the second robot coordinate system different from the first robot coordinate system and the second image captured by the imaging unit. Accordingly, the robot system can easily operate the first robot and the second robot based on the image captured by one imaging unit without mechanical calibration being carried out.

As described above, the control device and the robot system operate the first robot based on the first image captured by the imaging unit and the first robot coordinate system, and operate the second robot based on the second robot coordinate system different from the first robot coordinate system and the second image captured by the imaging unit. Accordingly, the control device and the robot system can easily operate the first robot and the second robot based on the image captured by one imaging unit without mechanical calibration being carried out.

### BRIEF DESCRIPTION OF THE DRAWINGS

The invention will be described with reference to the accompanying drawings, wherein like numbers reference like elements.

FIG. 1 is a view illustrating an example of a configuration of a robot system according to a first embodiment.

FIG. 2 is a view illustrating an example of a first target object stored in a container.

FIG. 3 is a view illustrating an example of a second target object.

FIG. 4 is a view illustrating an example of a hardware configuration of a control device.

FIG. 5 is a view illustrating an example of a functional configuration of a robot control device.

FIG. 6 is a flow chart illustrating an example of flow of processing in which the robot control device causes a robot to perform a predetermined work.

FIG. 7 is a view illustrating an example of a situation in which a position of a control point coincides with an imaging position.

FIG. 8 is a view illustrating an example of the first target object in a case where a posture of the first target object does not coincide with a holding posture.

FIG. 9 is a view illustrating an example of an angle of rotation of a shaft about a third axis in a case where the position and a posture of the control point in Step S120 coincide with the imaging position and an imaging posture.

FIG. 10 is a view illustrating an example of an angle of rotation of the shaft about the third axis in a case where the position and posture of the first target object in Step S160 coincide with a fitting position and a fitting posture.

FIG. 11 is a view illustrating an example of a position of the first target object in an up-and-down direction when the position and posture of the first target object in the processing of Step S160 coincide with the fitting position and the fitting posture.

FIG. 12 is a view illustrating an example of a configuration of a robot system according to a second embodiment.

FIG. 13 is a view illustrating an example of a dispenser.

FIG. 14 is a view illustrating an example of the functional configuration of a robot control device.

FIG. 15 is a flow chart illustrating an example of flow of processing in which the robot control device causes the robot to perform a predetermined work.

FIG. 16 is a view illustrating an example of an appearance of a first position detector being pressed by the robot by means of a tip portion of the dispenser.

FIG. 17 is a view illustrating an example of a case where an upper surface of a jig on which a droplet is discharged and an upper surface of the target object are seen from up to down.

FIG. 18 is a view illustrating an example of a configuration of a robot system according to a third embodiment.

FIG. 19 is a view illustrating an example of the functional configuration of a control device.

FIG. 20 is a flow chart illustrating an example of flow of processing in which the control device carries out double calibration.

FIG. 21 is a view illustrating an example of a configuration of the robot system when a first work and a second work are performed.

FIG. 22 is a flow chart illustrating an example of flow of processing performed by the control device in the first work and the second work.

FIG. 23 is a view illustrating an example of a configuration of the robot system when the control device carries out double calibration.

FIG. 24 is a flow chart illustrating an example of flow of a modification example of processing in which the control device carries out double calibration.

### DESCRIPTION OF EXEMPLARY EMBODIMENTS

### First Embodiment

Hereinafter, a first embodiment of the invention will be described with reference to the drawings.

### Configuration of Robot System

First, a configuration of a robot system 1 will be described.

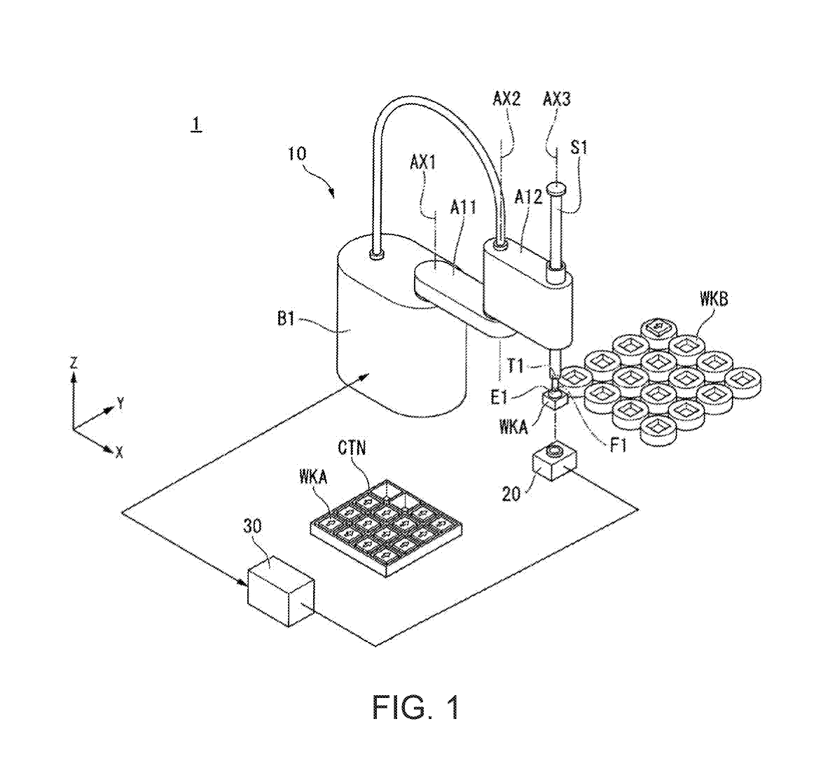

FIG. 1 is a view illustrating an example of the configuration of the robot system 1 according to the embodiment. The robot system 1 includes a robot 10, an imaging device 20, and a robot control device 30.

The robot 10 is a SCARA.

Instead of the SCARA, the robot 10 may be other robots including a cartesian coordinate robot, a one-armed robot, and a two-armed robot. The cartesian coordinate robot is, for example, a gantry robot.

In an example illustrated in FIG. 1, the robot 10 is provided on a floor. Instead of the floor, the robot 10 may be configured to be provided on a wall or a ceiling, a table or a jig, an upper surface of abase, and the like. Hereinafter, a direction orthogonal to a surface on which the robot 10 is provided, that is a direction from the center of the robot 10 to this surface will be referred to as down, and a direction opposite to this direction will be referred to as up for the convenience of description. The direction orthogonal to the surface on which the robot 10 is provided, that is the direction from the center of the robot 10 to this surface is, for example, a negative direction of the Z-axis in the world coordinate system or is a negative direction of the Z-axis in a robot coordinate system RC of the robot 10.

The robot 10 includes a support base B1 that is provided on the floor, a first arm A11 supported by the support base B1 so as to be capable of rotating about a first axis AX1, a second arm A12 supported by the first arm A11 so as to be capable of rotating about a second axis AX2, and a shaft S1 supported by the second arm A12 so as to be capable of rotating about a third axis AX3 and so as to be capable of translating in a third axis AX3 direction.

The shaft S1 is a cylindrical shaft. Each of a ball screw groove (not illustrated) and a spline groove (not illustrated) is formed in an external peripheral surface of the shaft S1. The shaft S1 is provided so as to penetrate an end portion, in an up-and-down direction, on a side opposite to the first arm A11, out of end portions of the second arm A12. In addition, in the shaft S1, a discoid flange that has a radius larger than the radius of the cylinder is provided on an upper end out of end portions of the shaft S1, in this example. The central axis of the cylinder coincides with the central axis of the flange.

On an end portion of the shaft S1, on which the flange is not provided, a first work portion F1 to which an end effector E1 can be attached is provided. Hereinafter, a case where a shape of the first work portion F1, when the first work portion F1 is seen from down to up, is a circle of which the center coincides with the central axis of the shaft S1 will be described as an example. The shape may be other shapes instead of the circle. The shaft S1 is an example of an operating shaft. In addition, the central axis is an example of an axis of the operating shaft.

The end effector E1 is attached to the first work portion F1. In this example, the end effector E1 is a vacuum gripper that is capable of adsorbing an object by sucking air. Instead of the vacuum gripper, the end effector E1 may be other end effectors including an end effector provided with a finger portion capable of gripping an object.

In this example, the end effector E1 adsorbs a first target object WKA placed in a container CTN illustrated in FIG. 1. The first target object WKA is, for example, an industrial component or member and device. Instead of the aforementioned objects, the first target object WKA may be a non-industrial component or member for daily necessities and device, may be a medical component or member and device, and may be a living body such as a cell. In the example illustrated in FIG. 1, the first target object WKA is represented as a rectangular parallelepiped object. Instead of a rectangular parallelepiped shape, the shape of the first target object WKA may be other shapes. In this example, a plurality of the first target objects WKA are placed in the container CTN. The end effector E1 adsorbs the first target object WKA one by one from the container CTN and moves the first target object WKA.

A control point T1 that is a tool center point (TCP) moving along with the first work portion F1 is set at the position of the first work portion F1. The position of the first work portion F1 is a position of the center of the circle, which is the shape of the first work portion F1 in a case where the first work portion F1 is seen from down to up. The position at which the control point T1 is set may be other positions correlated with the first work portion F1, instead of the position of the first work portion F1. In this example, the position of the center of the circle represents the position of the first work portion F1. Instead of the aforementioned position, a configuration in which the position of the first work portion F1 is represented by other positions may be adopted.

A control point coordinate system TC1 that is a three-dimensional local coordinate system representing the position and posture of the control point T1 (that is, the position and posture of the first work portion F1) is set on the control point T1. The position and posture of the control point T1 correspond to the position and posture in the robot coordinate system RC of the control point T1. The original of the control point coordinate system TC1 represents the position of the control point T1, that is, the position of the first work portion F1. In addition, a direction of each of the coordinate axes of the control point coordinate system TC1 represents the posture of the control point T1, that is, the posture of the first work portion F1. Hereinafter, a case where the Z-axis in the control point coordinate system TC1 coincides with the central axis of the shaft S1 will be described as an example. The Z-axis in the control point coordinate system TC1 is not necessarily required to coincide with the central axis of the shaft S1.

The support base B1 is fixed to the floor.

The first arm A11 moves in a horizontal direction since the first arm A11 rotates about the first axis AX1. In this example, the horizontal direction is a direction orthogonal to an up-and-down direction. The horizontal direction is, for example, a direction along the XY plane in the world coordinate system or a direction along the XY plane in the robot coordinate system RC that is the robot coordinate system of the robot 10.

The second arm A12 moves in the horizontal direction since the second arm A12 rotates about the second axis AX2. The second arm A12 includes a vertical motion actuator (not illustrated) and a rotating actuator (not illustrated), and supports the shaft S1. The vertical motion actuator moves (lifts up and down) the shaft S1 in the up-and-down direction by rotating, with a timing belt or the like, a ball screw nut provided in an outer peripheral portion of the ball screw groove of the shaft S1. The rotating actuator rotates the shaft S1 about the central axis of the shaft S1 by rotating, with the timing belt or the like, a ball spline nut provided in an outer peripheral portion of the spline groove of the shaft S1.

The imaging device 20 is, for example, a camera provided with a charge coupled device (CCD) or a complementary metal oxide semiconductor (CMOS) that is an imaging element which converts condensed light into an electrical signal. The imaging device 20 may be a monocular camera, may be a stereo camera, and may be a light field camera. In this example, the imaging device 20 images, in a direction from the bottom of the first target object WKA to the top thereof, an area that includes the first target object WKA adsorbed by the end effector E1 attached to the first work portion F1 of the shaft S1. Instead of the aforementioned direction, the imaging device 20 may be configured to image the area that includes the first target object WKA in other directions. In addition, although a configuration in which the robot system 1 includes the imaging device 20 has been described in this example, a configuration in which the robot 10 includes the imaging device 20 may be adopted instead.

Each of the actuators and the imaging device 20 included in the robot 10 is connected to the robot control device 30 via a cable so as to be capable of communicating with the robot control device 30. Accordingly, each of the actuators and the imaging device 20 operates based on a control signal acquired from the robot control device 30. Wired communication via the cable is, for example, carried out in accordance with standards including Ethernet (registered trademark) and USB. In addition, a part or the whole of the actuators and the imaging device 20 may be configured to be connected to the robot control device 30 by wireless communication carried out in accordance with communication standards including Wi-Fi (registered trademark).

The robot control device 30 operates the robot 10 by transmitting the control signal to the robot 10. Instead of being configured to be provided outside the robot 10, the robot control device 30 may be configured to be mounted in the robot 10. In addition, the robot control device 30 causes the robot 10 to perform a predetermined work. Hereinafter, a case where the robot control device 30 causes the robot 10 to perform a fitting work, which is a work of fitting the first target object WKA placed in the container CTN in a second target object WKB, as the predetermined work, will be described as an example. Instead of the aforementioned work, the predetermined work may be a work of bringing the first target object WKA into contact with the second target object WKB or other works including a work of bonding the first target object WKA to the second target object WKB.

Outline of Processing in which Robot Control Device Causes Robot to Perform Predetermined Work

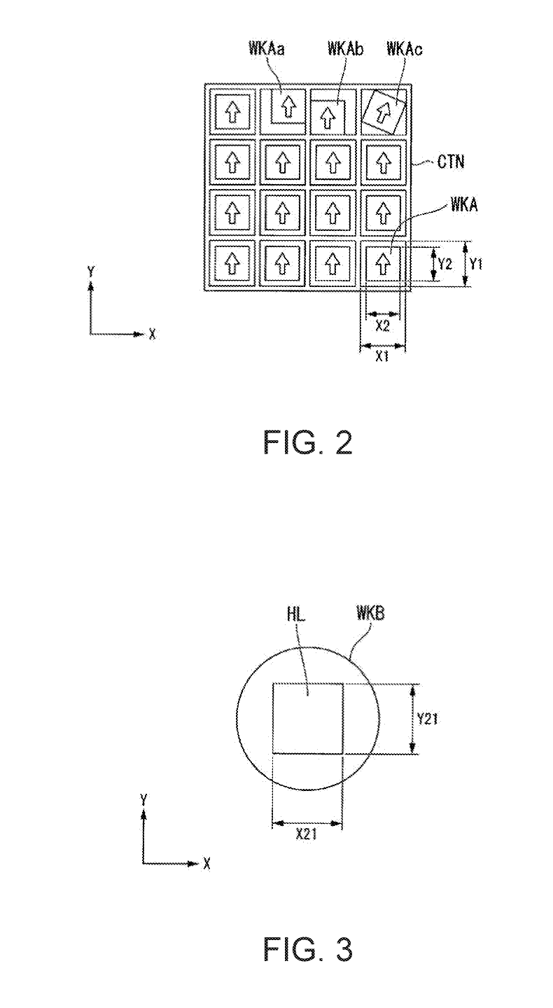

Hereinafter, the outline of processing in which the robot control device 30 causes the robot 10 to perform a predetermined work will be described with reference to FIG. 2 and FIG. 3.

FIG. 2 is a view illustrating an example of the first target object WKA stored in the container CTN. In FIG. 2, the container CTN is in the XY plane (plane parallel with the XY plane of the robot coordinate system RC, and in this example, the floor) in a case where the container CTN is seen from the top of the container CTN to the bottom thereof. The container CTN is divided into 4×4 divisions, and the first target object WKA is placed in each of the divisions. The direction of an arrow marked on the first target object WKA represents the posture of the first target object WKA in this example. A predetermined clearance is provided between the inside of the division of the container CTN and the outside of the first target object WKA. The divisions of the container CTN have the inside dimensions of X1×Y1, X1 being a length in an X-direction illustrated in FIG. 2 and Y1 being a length in a Y-direction orthogonal to the X-direction, as illustrated in FIG. 2. Meanwhile, the first target object WKA has the outside dimensions of X2×Y2. That is, a clearance of which one side in the X-direction is (X1−X2)/2 and one side in the Y-direction is (Y1−Y2)/2 is in between the division of the container CTN and the first target object WKA. X1 is longer than X2, and Y1 is longer than Y2.

In this example, a first target object WKAa out of the first target objects WKA is placed at the upper right within the division of the container CTN. In addition, a first target object WKAb out of the first target objects WKA is placed at the lower left within the division of the container CTN. In addition, a first target object WKAc out of the first target objects WKA is rotated and placed within the division of the container CTN. As described above, in some cases, the placed position and placed posture of each of the first target objects WKA placed in the container CTN vary. In such a case, once the first target object WKA placed in the container CTN is adsorbed by the end effector E1, the positions and postures of the adsorbed first target objects WKA vary in the XY plane. Herein, the position of the first target object WKA is represented by the position of the center of the first target object WKA, in this example. Instead of the aforementioned position, the position of the first target object WKA may be configured to be represented by other positions correlated with the first target object WKA. In this example, the posture of the first target object WKA is represented by a direction of each of the three sides of the rectangular parallelepiped first target object WKA which are orthogonal to each other in the robot coordinate system RC. Instead of the aforementioned posture, the posture of the first target object WKA may be configured to be represented by other directions correlated with the first target object WKA.

FIG. 3 is a view illustrating an example of the second target object WKB. In FIG. 3, the second target object WKB includes a recessed portion HL to which the first target object WKA is fitted at the center portion of the second target object WKB. The recessed portion HL has the inside dimensions of X21×Y21. A predetermined fitting in which the recessed portion HL having the inside dimensions of X21×Y21 is fitted to the first target object WKA having the outside dimensions of X2×Y2 is selected. In this example, the inside dimensions of the recessed portion HL and the outside of the first target object WKA are selected such that the first target object WKA is fitted to the second target object WKB.

The robot control device 30 moves the first target object WKA adsorbed by the end effector E1 into an area that can be imaged by the imaging device 20 by having the position and posture of the control point T1 coincide with an imaging position P1 and an imaging posture W1 that are a predetermined position and posture. The imaging position P1 is, for example, a position on an optical axis of the imaging device 20 within the area that can be imaged by the imaging device 20 and is a position where the first target object WKA adsorbed by the end effector E1 does not come into contact with the imaging device. The imaging posture W1 is a posture of the control point T1 at a time when the position of the control point T1 coincides with the imaging position P1. The imaging posture W1 may be any posture. Then, the robot control device 30 has the imaging device 20 image the first target object WKA gripped by the end effector E1.

The robot control device 30 calculates the position and posture of the first target object WKA based on an image captured by the imaging device 20. The robot control device 30 calculates a relative position and posture between the position and posture of the control point T1 and the position and posture of the first target object WKA based on the calculated position and posture of the first target object WKA. The robot control device 30 moves the end effector E1 based on the calculated position and posture, and has the position and posture of the first target object WKA coincide with a fitting position and a fitting posture that are a predetermined position and posture. The fitting position and fitting posture are a position and posture of the first target object WKA at a time when the first target object WKA is fitted to the recessed portion HL of the second target object WKB. The robot control device 30 has the position and posture of the first target object WKA adsorbed by the end effector E1 coincide with the fitting position and fitting posture according to the second target object WKB, which is a target to which the first target object WKA is fitted in a case where a plurality of the second target objects WKB exist.

When the robot control device 30 causes the robot 10 to perform a predetermined work, the position of the first target object WKA in the horizontal direction changes according to a processing accuracy or an assembling accuracy of the shaft S1 in some cases once the robot control device 30 operates the shaft S1 to change the position of the first target object WKA adsorbed by the end effector E1 in the up-and-down direction. That is because the shaft S1 moves up and down via the spline groove.

Thus, when the robot control device 30 causes the robot 10 to perform a predetermined work, from a time when the imaging device 20 images the first target object WKA at a first position (the position of the first target object WKA in a case where the position of the control point T1 coincides with the imaging position P1) until a time when the first target object WKA reaches a second position (in this example, the fitting position) which is in the same first direction (in this example, the up-and-down direction) as the first position, the robot control device 30 in this example moves the first target object WKA in a second direction, which is different from the first direction, based on an image captured by the imaging device (in this example, a captured image). The robot control device 30 may move the first target object not only in the second direction but also in the first direction during the time when the first target object is moved from the first position to the second position. In this example, “position is to the same” means that translation in the first direction is within a range of ±1 mm and rotation of the shaft S1 is within a range of ±5°. Accordingly, the robot control device 30 can restrict changes in the position of the first target object WKA in the horizontal direction that occur in response to the movement of the shaft S1 in the up-and-down direction. As a result, the robot control device 30 can restrict the position of the first target object WKA from being shifted in the second direction in response to the movement of the first target object WKA in the first direction. Hereinafter, the processing in which the robot control device 30 causes the robot 10 to perform a predetermined work and a positional relationship between the robot 10 and the imaging device 20 in the processing will be described.

### Hardware Configuration of Robot Control Device

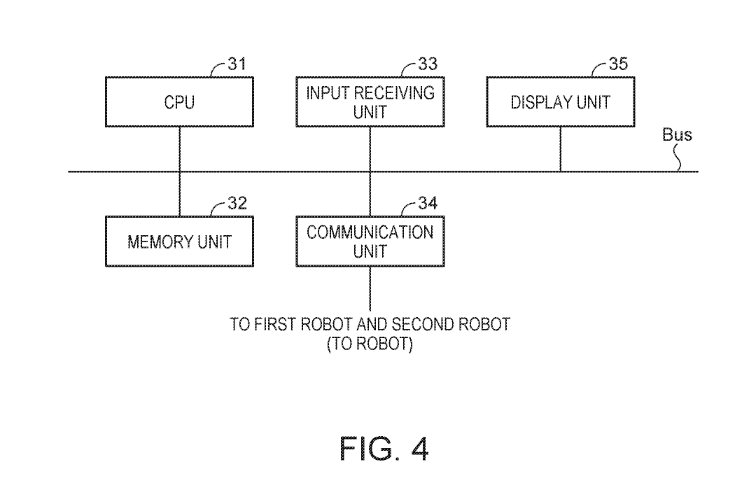

Hereinafter, a hardware configuration of the robot control device 30 will be described with reference to FIG. 4.

FIG. 4 is a view illustrating an example of the hardware configuration of the robot control device 30. The robot control device 30 includes, for example, a central processing unit (CPU) 31, a memory unit 32, an input receiving unit 33, a communication unit 34, a display unit 35. The robot control device 30 communicates with the robot 10 via the communication unit 34. The aforementioned configuration elements are connected so as to be capable of communicating with each other via a bus.

The CPU 31 executes various programs stored in the memory unit 32.

The memory unit 32 includes, for example, a hard disk drive (HDD) or a solid state drive (SSD), an electrically erasable programmable read-only memory (EEPROM), a read-only memory (ROM), and a random access memory (RAM). Instead of being mounted in the robot control device 30, the memory unit 32 may be an external type memory device connected by a digital input and output port such as a USB. The memory unit 32 stores various types of information, images, and programs processed by the robot control device 30.

The input receiving unit 33 is, for example, a teaching pendant provided with a keyboard and a mouse, or a touchpad, or other input devices. The input receiving unit 33 may be configured to be integrated with the display unit 35, as a touch panel.

The communication unit 34 is configured to include, for example, a digital input and output port such as a USB or an Ethernet (registered trademark) port.

The display unit 35 is, for example, a liquid crystal display panel or an organic electroluminescent (EL) display panel.

### Functional Configuration of Control Device

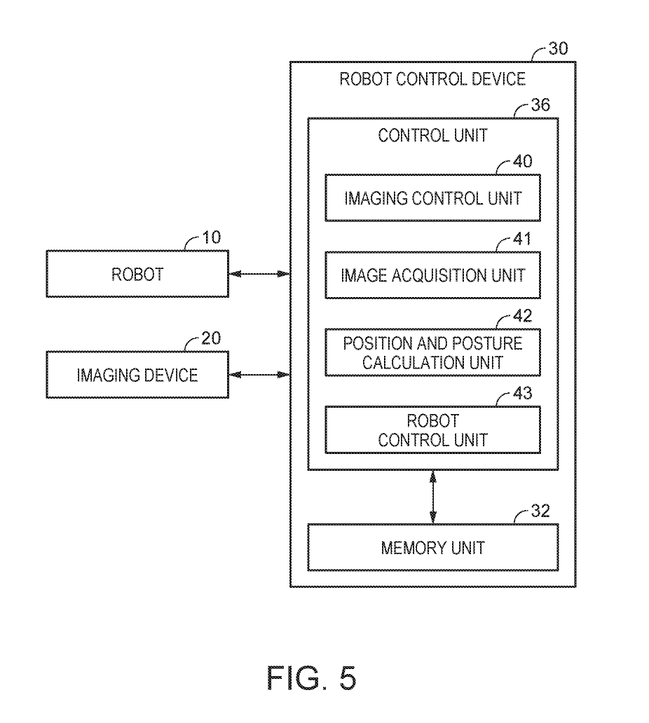

Hereinafter, a functional configuration of the robot control device 30 will be described with reference to FIG. 5.

FIG. 5 is a view illustrating an example of the functional configuration of the robot control device 30. The robot control device 30 includes the memory unit 32 and a control unit 36.

The control unit 36 controls the entire robot control device 30. The control unit 36 includes an imaging control unit 40, an image acquisition unit 41, a position and posture calculation unit 42, and a robot control unit 43. The functions of the aforementioned functional units included in the control unit 36 are realized, for example, by various programs stored in the memory unit 32 being executed by the CPU 31. In addition, a part or the whole of the functional units may be a hardware functional unit such as large scale integration (LSI) and application specific integrated circuit (ASIC).

The imaging control unit 40 causes the imaging device 20 to image the area that can be imaged by the imaging device 20.

The image acquisition unit 41 acquires the image captured by the imaging device 20 from the imaging device 20.

The position and posture calculation unit 42 calculates the position and posture of the first target object WKA based on the captured image acquired by the image acquisition unit 41. In this example, the position and posture calculation unit 42 calculates the position and posture of the first target object WKA by pattern matching. Instead of pattern matching, the position and posture calculation unit 42 may be configured to calculate the position and posture of the first target object WKA with a marker or the like provided in the first target object WKA.

The robot control unit 43 operates the robot 10 to cause the robot 10 to perform a predetermined work.

Processing in which Robot Control Device Causes Robot to Perform Predetermined Work

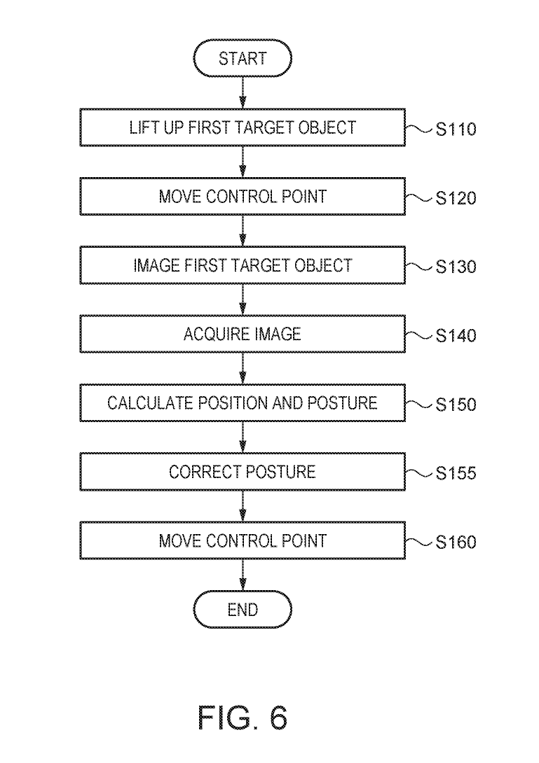

Hereinafter, the processing in which the robot control device 30 causes the robot 10 to perform a predetermined work will be described with reference to FIG. 6.

FIG. 6 is a flow chart illustrating an example of the flow of the processing in which the robot control device causes the robot 10 to perform a predetermined work. Hereinafter, a case where only one first target object WKA exists will be described as an example.

The robot control unit 43 reads adsorption position information stored in memory unit 32 in advance from the memory unit 32. The adsorption position information is information indicating an adsorption position which is a position determined in advance for having the position of the control point T1 coincide with the adsorption position when the first target object WKA is adsorbed from the container CTN and then lifted up. The adsorption position is, for example, a position directly above the center of the division of the container CTN, and is a position at which an end portion of the end effector E1 on a side opposite to a shaft S1 side out of end portions of the end effector E1 comes into contact with the first target object WKA. The robot control unit 43 moves the control point T1 based on the read adsorption position information, and adsorbs the first target object WKA placed in the container CTN by means of the end effector E1 (Step S110). Then, the robot control unit 43 causes the robot 10 to lift up the first target object WKA adsorbed by the end effector E1 by raising the shaft S1.

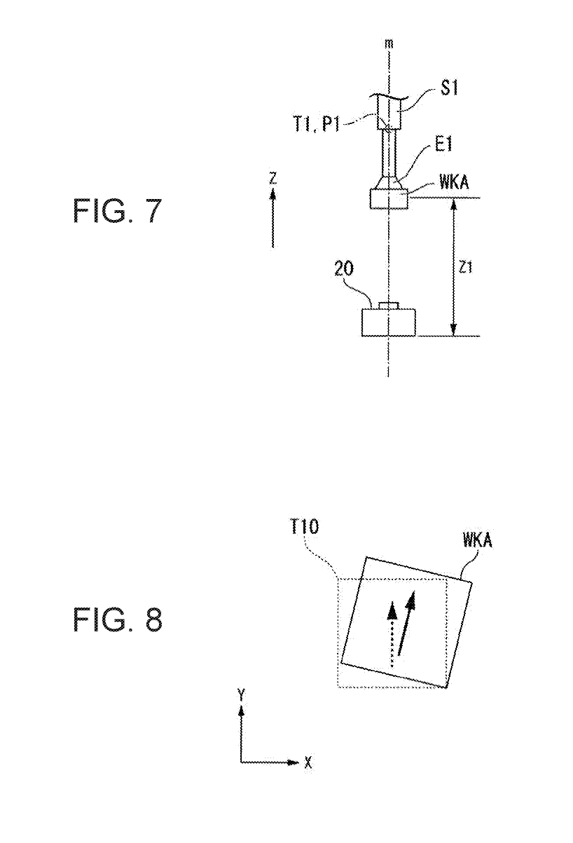

Next, the robot control device 30 has the position and posture of the control point T1 coincide with the imaging position P1 and the imaging posture W1 (Step S120). Herein, a situation in which the position of the control point T1 coincides with the imaging position P1 will be described with reference to FIG. 7.

FIG. 7 is a view illustrating the situation in which the position of the control point T1 coincides with the imaging position P1. In addition, FIG. 7 is a view in a case where the situation is seen in the horizontal direction. In the example illustrated in FIG. 7, the imaging position P1 is a position on an optical axis m which is the optical axis of the imaging device 20. In addition, the imaging position P1 is a position obtained by the position of the first target object WKA adsorbed by the end effector E1 in the up-and-down direction being elevated by a height Z1 from the position of the imaging device 20 in the up-and-down direction in a case where the position of the control point T1 coincides with the imaging position P1. The up-and-down direction is an example of the first direction.

Next, the imaging control unit 40 causes the imaging device 20 to image the area that includes the first target object WKA (Step S130). Next, the image acquisition unit 41 acquires the image captured by the imaging device 20 in Step S130 from the imaging device 20 (Step S140).

Next, the position and posture calculation unit 42 calculates the position and posture of the first target object WKA based on the captured image acquired by the image acquisition unit 41 in Step S140. The position and posture of the first target object WKA are the position and posture of the first target object WKA in the robot coordinate system RC. The position and posture calculation unit 42 calculates the position and posture by pattern matching or the like. In addition, the position and posture calculation unit 42 calculates the current position and posture of the control point T1 based on forward kinematics. The position and posture of the control point T1 are the position and posture of the control point T1 in the robot coordinate system RC. The position and posture calculation unit 42 calculates a relative position and posture between the position and posture of the first target object WKA and the current the position and posture of the control point T1 based on the calculated position and posture of the first target object WKA and the current the position and posture of the control point T1 (Step S150).

Next, the robot control unit 43 determines whether or not the posture of the first target object WKA calculated by the position and posture calculation unit 42 in Step S150 corresponds to a holding posture which is a posture determined in advance. For example, the robot control unit 43 reads holding posture information stored in the memory unit 32 in advance from the memory unit 32, and determines whether or not the posture corresponds to the holding posture by comparing the holding posture indicated by the read holding posture information with the posture of the first target object WKA calculated by the position and posture calculation unit 42 in Step S150. The holding posture information is information indicating the holding posture. The robot control unit 43 may be differently configured to read a template image stored in the memory unit 32 in advance from the memory unit 32, to compare the read template image with the captured image acquired by the image acquisition unit 41 in Step S140, and to determined whether or not the posture of the first target object WKA detected from the captured image corresponds to the holding posture. Only in a case where the posture of the first target object WKA calculated by the position and posture calculation unit 42 in Step S150 does not correspond to the holding posture, the robot control unit 43 rotates the shaft S1 and executes posture correcting processing having the posture of the first target object WKA coincide with the holding posture (Step S155). At this time, the robot control unit 43 has the posture of the first target object WKA coincide with the holding posture without changing the position of the control point T1 in the up-and-down direction.

Herein, a relationship between the posture of the first target object WKA and the holding posture will be described with reference to FIG. 8.

FIG. 8 is a view illustrating an example of the first target object WKA in a case where the posture of the first target object WKA does not coincide with the holding posture. In FIG. 8, a dotted line T10 represents the first target object WKA in a case where the posture of the first target object WKA coincides with the holding posture. Only in a case where the posture of the first target object WKA does not coincide with the holding posture as illustrated in FIG. 8, the robot control unit 43 has the posture of the first target object WKA coincide with the holding posture without changing the position of the control point T1 in the up-and-down direction.

Even in a case where the shaft S1 is rotated in Step S155, as described above, the position of the first target object WKA in the horizontal direction changes in some cases according to the processing accuracy or assembling accuracy of the shaft S1. However, since the rotation of the shaft S1 caused by the posture correcting processing falls within a range of ±5°, an amount by which the position of the first target object WKA in the horizontal direction changes falls within a range of ±1 mm. That is, in this example, it would be described that the position does not change by the rotation of the shaft S1 caused by the posture correcting processing.

After the processing of the Step S155 is performed, the robot control unit 43 reads the fitting position and posture information stored in the memory unit 32 in advance from the memory unit 32. The fitting position and posture information is information indicating the aforementioned fitting position and fitting posture. The robot control unit 43 has the position and posture of the first target object WKA coincide with the fitting position and the fitting posture based on the read fitting position and posture information, the relative position and posture between the position and posture of the first target object WKA and the position and posture of the control point T1 calculated in Step S150, causes the first target object WKA to be fitted to the second target object WKB (Step S160), and terminates the processing.

Herein, when having the position and posture of the first target object WKA coincide with the fitting position and the fitting posture in the processing of Step S160, the robot control unit 43 has an angle of rotation of the shaft S1 about the third axis AX3 coincide with the angle of rotation of the shaft S1 about the third axis AX3 in a case where the position and posture of the control point T1 in Step S120 coincides with the imaging position P1 and the imaging posture W1.

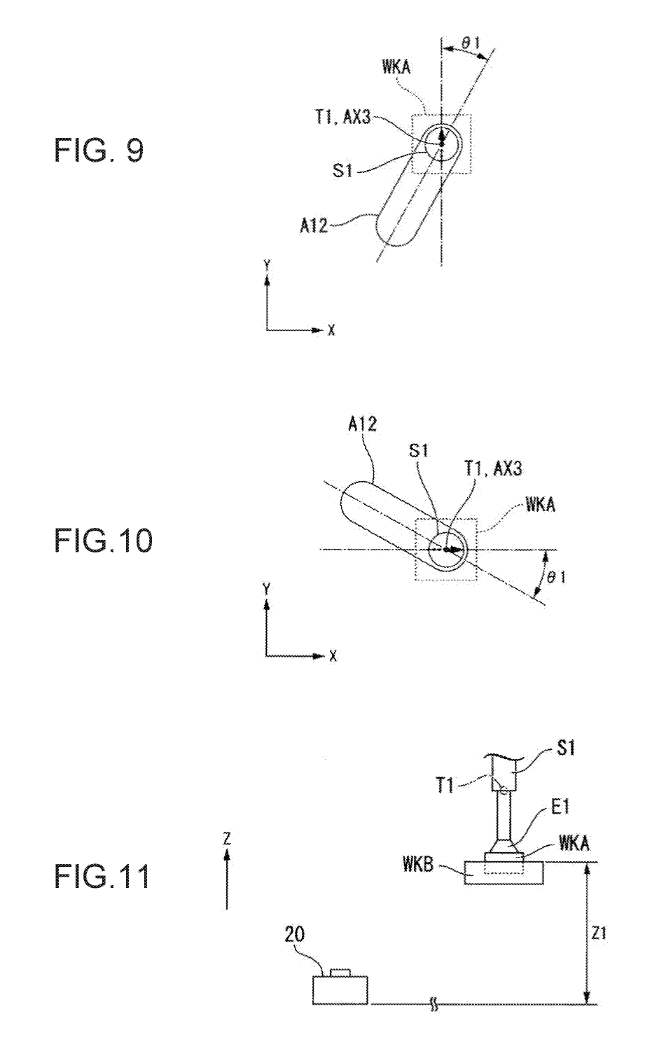

FIG. 9 is a view illustrating an example of the angle of rotation of the shaft S1 about the third axis AX3 in a case where the position and posture of the control point T1 in Step S120 coincides with the imaging position P1 and the imaging posture W1. In the example illustrated in FIG. 9, the angle of rotation of the shaft S1 about the third axis AX3 is an angle θ1 in a case where the position of the control point T1 coincides with the imaging position P1. In addition, in FIG. 9, the angle of rotation of the shaft S1 about the third axis AX3 is represented by a direction of an arrow marked at the first target object WKA.

For example, the robot control unit 43 maintains the angle of rotation of the shaft S1 about the third axis AX3 at the angle θ1 until the robot control unit 43 operates, from the state illustrated in FIG. 9, the second arm A12 and the first arm A11 (not illustrated) of the robot 10 to move the first target object WKA in the horizontal direction, and further operates the vertical motion actuator to have the position and posture of the first target object WKA coincide with the fitting position and the fitting posture.

FIG. 10 is a view illustrating an example of the angle of rotation of the shaft S1 about the third axis AX3 in a case where the position and posture of the first target object WKA in Step S160 coincide with the fitting position and the fitting posture. In FIG. 10, the angle of rotation of the shaft S1 about the third axis AX3 is represented by a direction of an arrow marked at the first target object WKA. As illustrated in FIG. 10, the angle of rotation of the shaft S1 about the third axis AX3 in a case where the position of the first target object WKA coincides with the fitting position is maintained at the angle θ1. From the state illustrated in FIG. 9 to the state illustrated in FIG. 10, the angle of rotation of the shaft S1 about the third axis AX3 may be changed from the angle θ1.

Accordingly, the robot control device 30 can restrict changes in the position of the control point T1 in the horizontal direction in response to the rotation of the shaft S1 about the third axis AX3, that is, changes in the position of the first target object WKA in the horizontal direction. As a result, the robot control device 30 can restrict the position of the first target object WKA which is at the fitting position from being shifted in the horizontal direction. The horizontal direction is an example of the second direction.

In addition, in the robot system 1, when the position and posture of the first target object WKA in the processing of Step S160 coincides with the fitting position and the fitting posture, the position of the second target object WKB in the up-and-down direction is adjusted in advance such that the position of the first target object WKA in the up-and-down direction coincides with the position of the first target object WKA in the up-and-down direction at a time when the first target object WKA is imaged by the imaging device 20 in Step S130.

FIG. 11 is a view illustrating an example of the position of the first target object WKA in the up-and-down direction when the position and posture of the first target object WKA in the Step S160 coincides with the fitting position and the fitting posture. In addition, FIG. 11 is a view in a case where the first target object WKA is seen in the horizontal direction. In FIG. 11, the first target object WKA is fitted to the second target object WKB. In this state, the position of the first target object WKA in the up-and-down direction is a position obtained by the first target object WKA being elevated by the height Z1 from the position of the imaging device 20 in the up-and-down direction. That is, in this example, when the position and posture of the first target object WKA coincide with the fitting position and the fitting posture, the position of the first target object WKA in the up-and-down direction coincides with the position of the first target object WKA in the up-and-down direction at a time when the first target object WKA is imaged by the imaging device 20 in Step S130.

That is, in this example, the robot 10 moves the first target object WKA in the horizontal direction based on the image captured by the imaging device 20 from a time when the imaging device 20 images the first target object WKA which is at the position of the first target object WKA while the position of the control point T1 coincides with an imaging position until a time when the first target object WKA reaches the fitting position which is in the same up-and-down direction as the position. Accordingly, the robot 10 can restrict the position of the first target object WKA from being shifted in the horizontal direction in response to the movement of the first target object WKA in the up-and-down direction.

As described above, the robot control device 30 causes the robot 10 to perform, as the predetermined work, the work of fitting the first target object WKA placed in the container CTN in a second target object WKB. In a case where a plurality of the first target objects WKA exist, the robot control device 30 may be configured to perform the processing of Step S110 to Step S160 again after the processing of Step S160 is performed once. In addition, the robot control device 30 may be configured to perform, in Step S160, any one of the processing described in FIG. 9 and FIG. 10 and the processing described in FIG. 11.

As described above, the robot 10 in the present embodiment moves the first target object in the second direction (in this example, the horizontal direction), which is different from the first direction, based on the image captured by the imaging device from the time when the imaging device (in this example, the imaging device 20) images the first target object (in this example, the first target object WKA) which is at the first position (in this example, the position of the first target object WKA in a case where the position of the control point T1 coincides with the imaging position P1) until a time when the first target object reaches the second position (in this example, the fitting position) which is in the same first direction (in this example, the up-and-down direction) as the first position. Accordingly, the robot 10 makes the position of the first target object in the first direction at the time of imaging identical to the position of the first target object in the first direction at the time of reaching the second position. As a result, the robot 10 can restrict the first target object from being shifted in the second direction in response to the movement of the first target object in the first direction.

In addition, the robot 10 moves the first target object by means of a movement unit (in this example, the support base B1, the first arm A11, the second arm A12, and shaft S1) which is capable of moving the first target object in the first direction and the second direction. Accordingly, the robot 10 can restrict the first target object from being shifted in the second direction in response to the movement of the first target object in the first direction caused by the movement unit.

In addition, the robot 10 moves the first target object in the first direction and in the second direction by means of the first arm (in this example, the first arm A11), the second arm (in this example, the second arm A12), and the operating shaft (in this example, the shaft S1). Accordingly, the robot 10 can restrict the first target object from being shifted in the second direction in response to the movement of the first target object in the first direction by means of the first arm, the second arm, and the operating shaft.

In addition, the robot 10 makes the angle of rotation of the operating shaft about the third axis AX3 at the time when the first target object at the first position is imaged by the imaging device the same as the angle of rotation of the operating shaft about the third axis AX3 at the time when the first target object reaches the second position. Accordingly, the robot 10 can restrict the first target object from being shifted in the second direction in response to the rotation of the operating shaft about the third axis AX3.

In addition, the robot 10 brings the first target object into contact with the second target object (in this example, the second target object WKB) at the second position. Accordingly, the robot can restrict the first target object from being shifted in the second direction in response to the movement of the first target object in the first direction in the work of bringing the first target object into contact with the second target object.

In addition, the robot 10 fits the first target object in the second target object at the second position. Accordingly, the robot 10 can restrict the first target object from being shifted in the second direction in response to the movement of the first target object in the first direction in the work of fitting the first target object in the second target object.

### Second Embodiment

Hereinafter, a second embodiment of the invention will be described with reference to the drawings.

### Configuration of Robot System

First, a configuration of a robot system 2 will be described.

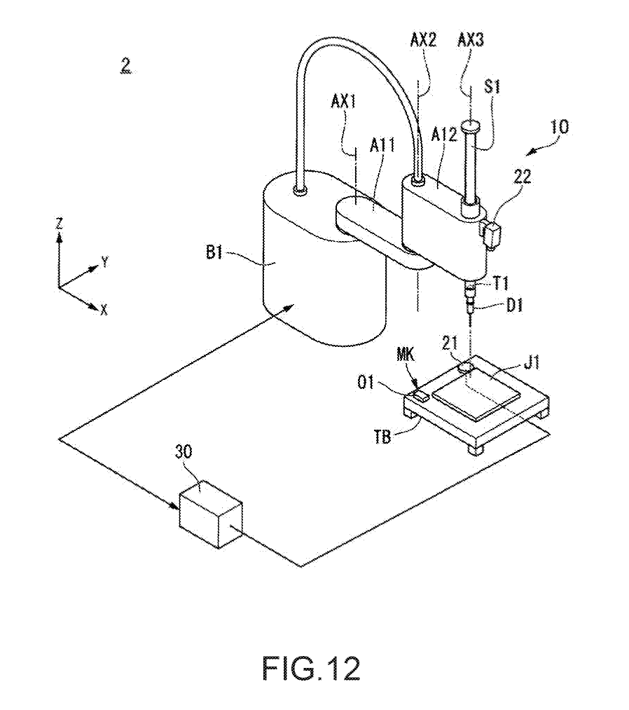

FIG. 12 is a view illustrating an example of the configuration of the robot system 2 according to this embodiment.

The robot system 2 of the embodiment is different from that of the first embodiment in that the robot system 2 includes the robot 10, a first position detector 21 and a second position detector 22. Hereinafter, the same reference numerals will be assigned to configuration members which are the same as that of the first embodiment, and description thereof will be omitted or simplified herein.

As illustrated in FIG. 12, the robot system 2 of the embodiment includes the robot 10, the first position detector 21, the second position detector 22, and the robot control device 30.

An attachable and detachable dispenser D1 which is capable of discharging a liquid is provided as the end effector on an end portion of the shaft S1 where the flange is not provided. Hereinafter, a case where the dispenser D1 discharges an adhesive as the liquid will be described as an example. The dispenser D1 may be configured to discharge other liquids including paint, grease, and water, instead of the adhesive.

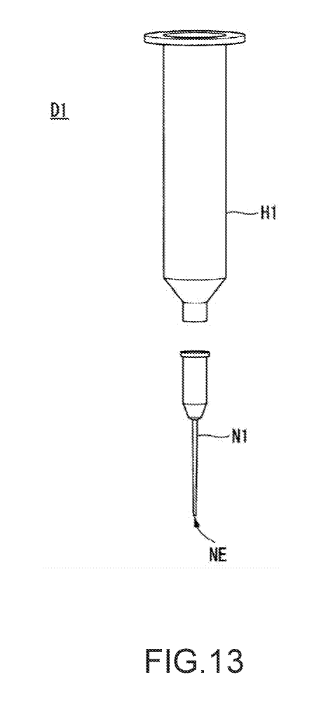

Herein, the dispenser D1 will be described with reference to FIG. 13.

FIG. 13 is a view illustrating an example of the dispenser D1. The dispenser D1 includes a syringe portion H1, a needle portion N1, and an air injection portion (not illustrated) that injects air into the syringe portion H1. The syringe portion H1 a container having a space into which the adhesive is put. The needle portion N1 has a needle discharging the adhesive which is put in the syringe portion H1. In addition, the needle portion N1 is attached to syringe portion H1 so as to be capable of being attached and detached. The needle portion N1 discharges the adhesive from a tip portion NE of the needle. That is, the dispenser D1 discharges the adhesive which is put in the syringe portion H1 from the tip portion NE of the needle portion N1 by the air injection portion (not illustrated) injecting air into the syringe portion H1. The dispenser D1 is an example of the discharging unit that discharges the liquid.

Out of end portions of the shaft S1, the control point T1 that is the TCP moving along with the end portion is set at a position of an end portion where the dispenser D1 is provided. The position of the end portion is a position of the center of a figure which represents the shape of the end portion in a case where the end portion is seen from down to up. In this example, the shape of the end portion is a circle. That is, the position of the end portion is the position of the center of the circle which is the shape of the end portion in a case where the end portion is seen from down to up. Instead of the position of the end portion, a position at which the control point T1 is set may be other positions correlated with the end portion.

The control point coordinate system TC that is the three-dimensional local coordinate system representing the position and posture of the control point T1 is set on the control point T1. The position and posture of the control point T1 are the position and posture of the control point T1 in the robot coordinate system RC. The robot coordinate system RC is the robot coordinate system of the robot 10. The original of the control point coordinate system TC represents the position of the control point T1. In addition, a direction of each of coordinate axes of the control point coordinate system TC represents a posture of the control point T1. Hereinafter, a case where the Z-axis in the control point coordinate system TC coincides with the central axis of the shaft S1 will be described as an example. The Z-axis in the control point coordinate system TC is not necessarily required to coincide with the central axis of the shaft S1.

Each of the actuators included in the robot 10 is connected to the robot control device 30 via the cable so as to be capable of communicating with the robot control device 30. Accordingly, each of the actuators operates based on the control signal acquired from the robot control device 30. Wired communication via the cable is, for example, carried out in accordance with standards including Ethernet (registered trademark) and USB. In addition, a part or the whole of the actuators may be configured to be connected to the robot control device 30 by wireless communication carried out in accordance with communication standards including Wi-Fi (registered trademark).

The first position detector 21 is, for example, a cylindrical microswitch. The first position detector 21 is connected to the robot control device 30 via the cable so as to be capable of communicating with the robot control device 30. Wired communication via the cable is, for example, carried out in accordance with standards including Ethernet (registered trademark) and USB. In addition, the first position detector 21 may be configured to be connected to the robot control device 30 by wireless communication carried out in accordance with communication standards including Wi-Fi (registered trademark).

In a case where an upper surface of the first position detector 21 is pressed by a predetermined length in a downward direction, the first position detector 21 is switched on and the first position detector 21 outputs information indicating the first position detector 21 is pressed to the robot control device 30. Accordingly, in a case where an object presses the first position detector 21 down, the first position detector 21 detects a height of a part of the object that is in contact with the first position detector 21. In this example, the height is a position in the Z-axis direction (up-and-down direction) in the robot coordinate system RC. Instead of the microswitch, the first position detector 21 may be other sensors or devices, such as a contact sensor, a laser sensor, a force sensor, and an imaging unit, which detect the height of the part of the object that is in contact with the first position detector 21. In a case where the first position detector 21 is a force sensor, for example, the first position detector 21 detects the height of the part of the object that is in contact with the first position detector 21 when the object is in contact with the first position detector 21 by the object coming into contact with (abutting against) the first position detector 21. In addition, instead of the cylinder, the shape of the first position detector 21 may be other shapes.

The second position detector 22 is, for example, a camera (imaging unit) that includes a CCD or a CMOS which is an imaging element converting condensed light into an electrical signal. In this example, the second position detector 22 is provided at a position where an area that includes a region in which the end effector (in this example, the dispenser D1) provided in the shaft S1 can perform a work can be imaged. Hereinafter, a case where the second arm A12 of the robot 10 is provided such that the second position detector 22 images the area from up to down will be described as an example. Instead of the aforementioned direction, the second position detector 22 may be configured to image the area in other directions.

Hereinafter, a case where the robot control device 30 (described later) detects, based on the image captured by the second position detector 22, the position of the object included in the captured image, under the robot coordinate system RC. This position is a position in a plane orthogonal to the up-and-down direction. Instead of the robot control device 30, the second position detector 22 may be configured to detect the position of the object included in the captured image based on the captured image, and to output information indicating the detected position to the robot control device 30. In addition, the second position detector 22 may be other sensors, such as a contact sensor, or devices insofar as the sensors or the devices are capable of detecting the position of a target object of which a position is intended to be detected, the position being in the plane orthogonal to the up-and-down direction of the target object.

The second position detector 22 is connected to the robot control device 30 via the cable so as to be capable of communicating with the robot control device 30. Wired communication via the cable is, for example, carried out in accordance with standards including Ethernet (registered trademark) and USB. In addition, the second position detector 22 may be configured to be connected to the robot control device 30 by wireless communication carried out in accordance with communication standards including Wi-Fi (registered trademark).

The robot control device 30 operates each of the robot 10, the first position detector 21, and the second position detector 22 by transmitting a control signal to each of the robot 10, the first position detector 21, and the second position detector 22. Accordingly, the robot control device 30 causes the robot 10 to perform a predetermined work. Instead of being configured to be provided outside the robot 10, the robot control device 30 may be configured to be mounted in the robot 10.

### Outline of Processing Performed by Robot Control Device

Hereinafter, the outline of processing performed by the robot control device 30 will be described.

In an example illustrated in FIG. 12, an upper surface of a working base TB is included in an area where the robot 10 can work by means of the dispenser D1. The working base TB is a table or a base. Each of the first position detector 21, a jig J1, and a target object O1 is disposed on an upper surface of the working base TB such that the first position detector 21, the jig J1, and the target object O1 do not overlap.

The jig J1 is a flat jig. In this example, the height of the jig J1 in the up-and-down direction, which is the height of the jig J1 with respect to the upper surface of the working base TB, is the same with the height at which the first position detector 21 is switched on, which is the height of the first position detector 21 with respect to the upper surface of the working base TB. The height of the jig J1 in the up-and-down direction, which is the height of the jig J1 with respect to the upper surface of the working base TB, may be different from the height at which the first position detector 21 is switched on, which is the height of the first position detector 21 with respect to the upper surface of the working base TB.

The target object O1 is an example of an discharging target to which the adhesive is discharged by the robot control device 30 by means of the robot 10. The target object O1 is, for example, a housing-like industrial component or member and device such as a printer, a projector, a personal computer (PC), and a multi-function mobile phone terminal (smartphone). Instead of the industrial component or member and device, the target object O1 may be a non-industrial component or member for daily necessities and device, and may be other objects including a living body such as a cell. In an example illustrated in FIG. 12, the target object O1 is represented as a rectangular parallelepiped object. Instead of the rectangular parallelepiped shape, the shape of the target object O1 may be other shapes.

The robot control device 30 causes the robot 10 to perform a predetermined work. In this example, the predetermined work is a work of discharging the adhesive to the target object O1. Instead of the aforementioned work, the predetermined work may be other works.

When causing the robot 10 to perform a predetermined work, the robot control device 30 detects the position of the discharging unit (in this example, the dispenser D1), which discharges the liquid, by means of the position detector (in this example, at least any one of the first position detector and the second position detector 22), and moves the discharging unit by means of the movement unit (in this example, the shaft S1) based on the detected result. Accordingly, the robot control device 30 can perform the work of discharging the liquid to the target object with high accuracy even in a case where the position of the discharging unit is shifted.

More specifically, the robot control device 30 detects a relative height between the height of the tip portion NE of the dispenser D1 and the height of the control point T1 using the first position detector 21. In addition, the robot control device 30 detects, using the second position detector 22, a relative in-plane position between the in-plane position of the tip portion NE of the dispenser D1 and the in-plane position of the control point T1. The in-plane position is a position in the XY plane of the robot coordinate system RC. The position in the XY plane is a position in a plane orthogonal to the Z-axis direction (up-and-down direction) of the robot coordinate system RC.

In addition, the robot control device 30 detects, using the second position detector 22, a position correlated with the target object O1 which is a position at which the robot 10 discharges the adhesive. In this example, a marker MK is provided on an upper surface of the target object O1. The marker MK is a mark indicating the position. The marker MK may be a part of the target object O1. The robot control device 30 detects the position at which the robot 10 discharges the adhesive based on the marker MK included in the image captured by the second position detector 22.

The robot control device 30 causes the robot 10 to perform a predetermined work based on the position detected by the first position detector 21 and the second position detector 22. Hereinafter, processing in which the robot control device 30 detects various positions using the first position detector 21 and the second position detector 22 and processing in which the robot control device 30 causes the robot 10 to perform a predetermined work based on the detected positions will be described in detail.

### Functional Configuration of Robot Control Device

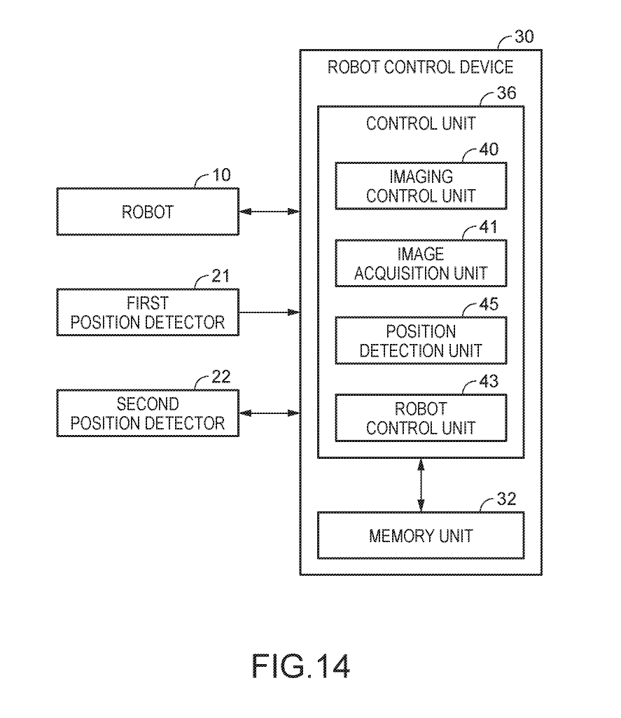

Hereinafter, a functional configuration of the robot control device 30 will be described with reference to FIG. 14.

FIG. 14 is a view illustrating an example of the functional configuration of the robot control device 30. The robot control device 30 includes the memory unit 32 and the control unit 36.

The control unit 36 controls the entire robot control device 30. The control unit 36 includes the imaging control unit 40, the image acquisition unit 41, a position detection unit 45, and the robot control unit 43.

The imaging control unit 40 causes the second position detector 22 to image an area that can be imaged by the second position detector 22.

The image acquisition unit 41 acquires the image captured by the second position detector 22 from the second position detector 22.

Once the information indicating that the first position detector 21 is pressed is acquired from the first position detector 21, the position detection unit 45 detects that the current height of the tip portion NE of the dispenser D1 is a discharging height, which is a predetermined height. The discharging height is at a predetermined separation distance (nozzle gap) in an upward direction from the height of the upper surface of the target object O1. The predetermined separation distance is, for example, 0.2 millimeters. Instead of the aforementioned distance, the predetermined separation distance may be other distances. In addition, the position detection unit 45 detects various in-plane positions based on the captured image acquired by the image acquisition unit 41.

The robot control unit 43 operates robot 10 based on the position detected by the position detection unit 45.

Processing in which Robot Control Device Causes Robot to Perform Predetermined Work

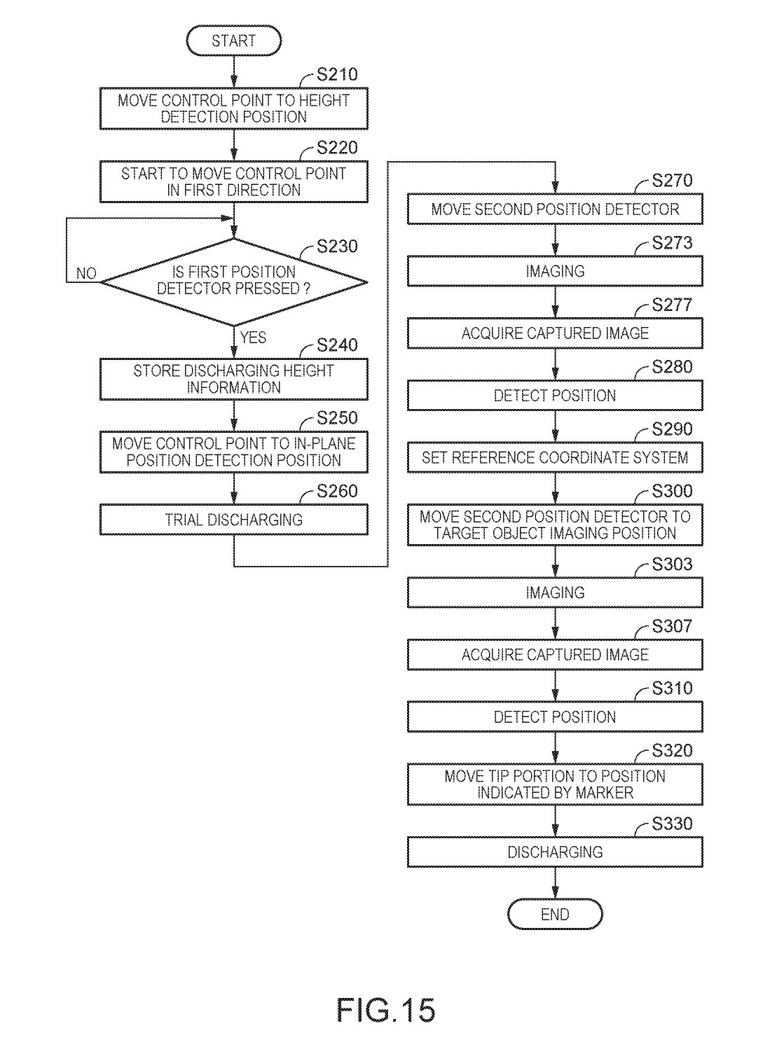

Hereinafter, processing in which the robot control device 30 causes the robot 10 to perform a predetermined work will be described with reference to FIG. 15.

FIG. 15 is a flow chart illustrating an example of the flow of the processing in which the robot control device 30 causes the robot 10 to perform a predetermined work.

The robot control unit 43 reads height detection position information from the memory unit 32. The height detection position information is information indicating a predetermined height detection position T2, and is information stored in the memory unit 32 in advance. In this example, the height detection position T2 is a position spaced away from the center of the upper surface of the first position detector 21 in the upward direction at a predetermined distance. A predetermined first distance is a distance at which the tip portion NE of the dispenser D1 does not come into contact with the upper surface of the first position detector 21 in a case where the position of the control point T1 coincides with the height detection position T2. The predetermined first distance is, for example, a distance 1.5 times longer than a distance between the control point T1 and the tip portion NE of the dispenser D1. The predetermined first distance may be other distances insofar as the tip portion NE of the dispenser D1 does not come into contact with the upper surface of the first position detector 21 in a case where the position of the control point T1 coincides with the height detection position T2. The robot control unit 43 operates the arm A based on the height detection position information read from the memory unit 32, and has the position of the control point T1 coincide with the height detection position T2 (Step S210).

Next, the robot control unit 43 operates the shaft S1, and starts to move the control point T1 in a first direction A1 (Step S220). The first direction A1 is a direction in which the upper surface of the first position detector 21 is pressed, and in this example, is the downward direction. Next, the robot control unit 43 causes the robot 10 to continue the operation started in Step S220 until the information indicating the first position detector 21 is pressed is acquired from the first position detector 21 (Step S230).

In a case where the information indicating the first position detector 21 is pressed is acquired from the first position detector 21 (Step S230: YES), the robot control unit 43 stops the operation of the shaft S1, and put an end to the movement of the control point T1 in the first direction A1. Then, the position detection unit 45 detects (specifies) that the current height of the tip portion NE of the dispenser D1 is the predetermined discharging height. The position detection unit 45 calculates the current height of the control point T1 based on forward kinematics, and stores discharging height information, which is information indicating a relative height between the calculated height and the height of the tip portion NE, in the memory unit 32 (Step S240).

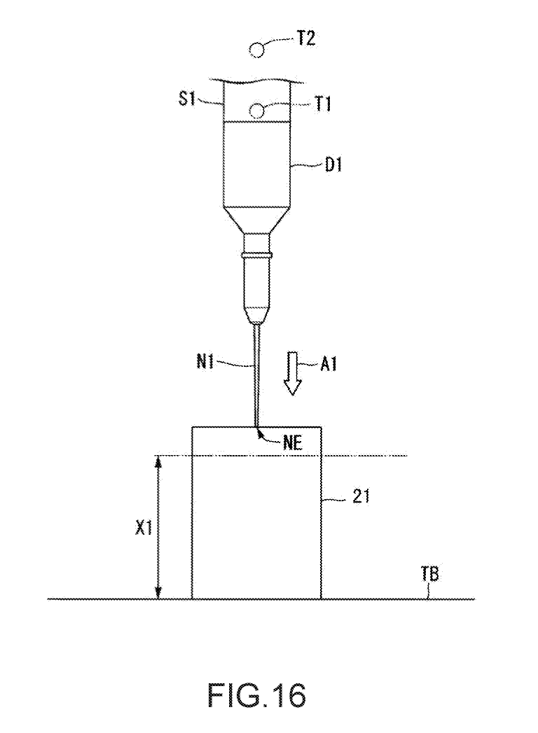

Herein, the processing of Step S210 to Step S240 will be described with reference to FIG. 16.

FIG. 16 is a view illustrating an example of an appearance of the first position detector 21 being pressed by the robot 10 by means of the tip portion NE of the dispenser D1. In addition, FIG. 16 is a view of the first position detector 21 and the dispenser D1 seen from a direction orthogonal to the up-and-down direction toward the first position detector 21 and the dispenser D1.

In Step S210, the robot control unit 43 moves the control point T1 based on the height detection position information, and has the position of the control point T1 coincide with the height detection position T2 illustrated in FIG. 16. Then, in Step S220, the robot control unit 43 operates the shaft S1, and starts to move the control point T1 in the first direction A1. FIG. 16 illustrates the control point T1 which is in the middle of moving in the first direction A1 in Step S220. For this reason, the position of the control point T1 is lower than the height detection position T2 in FIG. 16.

By such a movement of the control point T1 in the first direction A1, the tip portion NE of the dispenser D1 comes into contact with the upper surface of the first position detector 21 as illustrated in FIG. 16. The robot control unit 43 moves the control point T1 in the first direction A1 until the information indicating the first position detector 21 is pressed is acquired from the first position detector 21 in Step S230.

In a case where the information indicating the first position detector 21 is pressed is acquired from the first position detector 21 in Step S230, that is, in a case where the height of the tip portion NE coincides with a discharging height X1 illustrated in FIG. 16, the robot control unit 43 stops the operation of the shaft S1 and puts an end to the movement of the control point T1 in the first direction A1 in Step S240. Then, the position detection unit 45 calculates the current height of the control point T1 based on forward kinematics, and stores the discharging height information, which is information indicating a relative height between the calculated height and the height of the tip portion NE, in the memory unit 32.

After the processing of Step S240 is performed, the robot control unit 43 reads in-plane position detection position information from the memory unit 32. The in-plane position detection position information is information indicating an in-plane position detection position T3, and is information stored in advance in the memory unit 32. In this example, the in-plane position detection position T3 is information indicating a position included in the upper surface of the jig J1 in a case where the jig J1 is seen from up to down, and is a position spaced away from the center of the upper surface of the jig J1 in the upward direction at a predetermined second distance. The predetermined second distance is a distance at which the tip portion NE of the dispenser D1 does not come into contact with the upper surface of the jig J1 in a case where the position of the control point T1 coincides with the in-plane position detection position T3. The predetermined second distance is, for example, a distance 1.5 times longer than a distance between the control point T1 and the tip portion NE of the dispenser D1. The predetermined second distance may be other distances insofar as the tip portion NE of the dispenser D1 does not come into contact with the upper surface of the jig J1 in a case where the position of the control point T1 coincides with the in-plane position detection position T3. The robot control unit 43 operates the shaft S1 based on the in-plane position detection position information read from the memory unit 32, and has the in-plane position of the control point T1 coincide with the in-plane position detection position T3 (Step S250).

Next, the robot control unit 43 reads the discharging height information stored in the memory unit 32 from the memory unit 32. In this example, the height of the jig J1 is the height of the upper surface of the target object O1 which is a surface to which the adhesive is discharged. For this reason, the robot control unit 43 moves the control point T1 based on the discharging height information read from the memory unit 32, and has the height of the tip portion NE coincide with the predetermined discharging height. Then, the robot control unit 43 performs a trial discharging (Step S260). The trial discharging is discharging the adhesive on trial before discharging the adhesive onto the upper surface of the target object O1. Specifically, the trial discharging is discharging the adhesive put in the syringe portion H1 onto the upper surface of the jig J1 from the tip portion NE of the needle portion N1 by injecting air within the syringe portion H1. A position (point) to which the adhesive is discharged in the trial discharging, which is a position on the upper surface of the jig J1, is an example of a trial discharging point. Although a case where only one position, that is the trial discharging point, exists has been described in this example, the robot control unit 43 may be configured to forma plurality of trial discharging points on the upper surface of the jig J1 by performing a plurality of times of trial discharging. In addition, the jig J1 on which the trial discharging has been performed is an example of the object. Instead of being configured to perform the trial discharging onto the upper surface of the jig J1, the robot control unit 43 may be configured to perform the trial discharging onto other objects including the upper surface of the target object O1.

Next, the robot control unit 43 reads second position detector position information from the memory unit 32. The second position detector position information is information indicating a relative position between the position of the second position detector 22 in the robot coordinate system RC and the position of the control point T1 in the robot coordinate system RC, and is information stored in advance in the memory unit 32. The robot control unit 43 moves the control point T1 based on the second position detector position information read from the memory unit 32, and has the in-plane position of the second position detector 22 coincide with the in-plane position of the control point T1 when the trial discharging is performed in Step S260. In addition, the robot control unit 43 moves the control point T1 based on the second position detector position information read from the memory unit 32, and has the height of the second position detector 22 coincide with a predetermined imaging height (Step S270). The predetermined imaging height is a height at which the tip portion NE of the dispenser D1 does not come into contact with the upper surface of the jig J1 in a case where the height of the second position detector 22 coincides with the predetermined imaging height. In addition, the predetermined imaging height is a height at which a droplet F1, which is the adhesive discharged on the upper surface of the jig J1 by the trial discharging in Step S260, can be imaged.

Next, the imaging control unit 40 causes the second position detector 22 to image an area that includes the droplet F1 discharged on the upper surface of the jig J1 by the trial discharging in Step S260 (Step S273). The captured image of the area that includes the droplet F1 (trial discharging point), which is the image captured by the second position detector 22 in Step S273, is an example of a first image.

Next, the image acquisition unit 41 acquires the image captured by the second position detector 22 in Step S273 from the second position detector 22 (Step S277).

Next, the position detection unit 45 detects a position on the captured image of the droplet F1 included in the captured image based on the captured image acquired by the image acquisition unit 41 in Step S277. For example, the position detection unit 45 detects this position by pattern matching or the like based on the captured image acquired by the image acquisition unit 41 in Step S277. The position detection unit 45 calculates the in-plane position of the droplet F1 based on the detected position and the current in-plane position of the control point T1. Herein, on the position on the captured image, a relative position from the in-plane position of the control point T1 to the in-plane position corresponding to the position on the captured image is correlated in advance by calibration or the like. Excluding an error, the calculated in-plane position of the droplet F1 should coincide with the in-plane position of the tip portion NE when the trial discharging is performed in Step S260. Therefore, the position detection unit 45 calculates a relative position between the in-plane position of the tip portion NE and the in-plane position of the control point T1 based on the calculated in-plane position of the droplet F1 and the in-plane position of the control point T1 when the trial discharging is performed in Step S260 (Step S280). Herein, the position of the droplet F1 on the captured image is represented by the position of the center of the droplet F1 on the captured image (or the center of the drawing), in this example. Instead of being configured to be represented by the position of the center of the droplet F1 on the captured image (or the center of the drawing), the position of the droplet F1 on the captured image may be configured to be represented by positions of other parts correlated with the droplet F1 on the captured image.

Next, the position detection unit 45 sets a reference coordinate system LC which is a local coordinate system of which the original is the in-plane position of the droplet F1 with respect to the calculated in-plane position of the droplet F1 in Step S280 (Step S290). In this example, the reference coordinate system LC is the two-dimensional local orthogonal coordinate system. Instead of the two-dimensional local orthogonal coordinate system, the reference coordinate system LC may be other orthogonal coordinate systems including the three-dimensional local orthogonal coordinate system, and may be other coordinate systems including the polar coordinate system. Then, the position detection unit 45 calculates the current position of the tip portion NE in the reference coordinate system LC based on the relative position between the in-plane position of the tip portion NE and the in-plane position of the control point T1, which is calculated in Step S280.

Next, the robot control unit 43 reads target object imaging position information from the memory unit 32. The target object imaging position information is information indicating a target object imaging position T4, which is a position of the second position detector 22 in the robot coordinate system RC when the second position detector 22 images the marker MK provided on the upper surface of the target object O1, and is information stored in advance in the memory unit 32. The target object imaging position T4 is a position at which an area that includes the upper surface of the target object O1 can be imaged, and is a position at which the tip portion NE of the dispenser D1 does not come into contact with the upper surface of the target object O1 in a case where the position of the second position detector 22 coincides with the target object imaging position T4. The robot control unit 43 moves the control point T1 based on the target object imaging position information read from the memory unit 32, and has the position of the second position detector 22 coincide with the target object imaging position T4 (Step S300).

Next, the imaging control unit 40 causes the second position detector 22 to image the area that includes the upper surface of the target object O1, that is, an area that includes the marker MK (Step S303). The captured image of the area that includes the marker MK, which is the image captured by the second position detector 22 in Step S303, is an example of a second image. Next, the image acquisition unit 41 acquires the image captured by the second position detector 22 in Step S303 from the second position detector 22 (Step S307).

Next, the position detection unit 45 detects the position on the captured image, which is a position indicated by the marker MK included in the captured image, based on the captured image acquired by the image acquisition unit 41 in Step S307. For example, the position detection unit 45 detects this position by pattern matching or the like based on the captured image acquired by the image acquisition unit 41 in Step S307. The position detection unit 45 calculates a position indicated by the marker MK in the reference coordinate system LC based on the detected position and the current in-plane position of the control point T1. The position detection unit 45 calculates a vector V1 indicating displacement from this position to the position indicated by the marker in the reference coordinate system LC MK based on the calculated position and the position of the tip portion NE in the reference coordinate system LC calculated in Step S290 (Step S310).

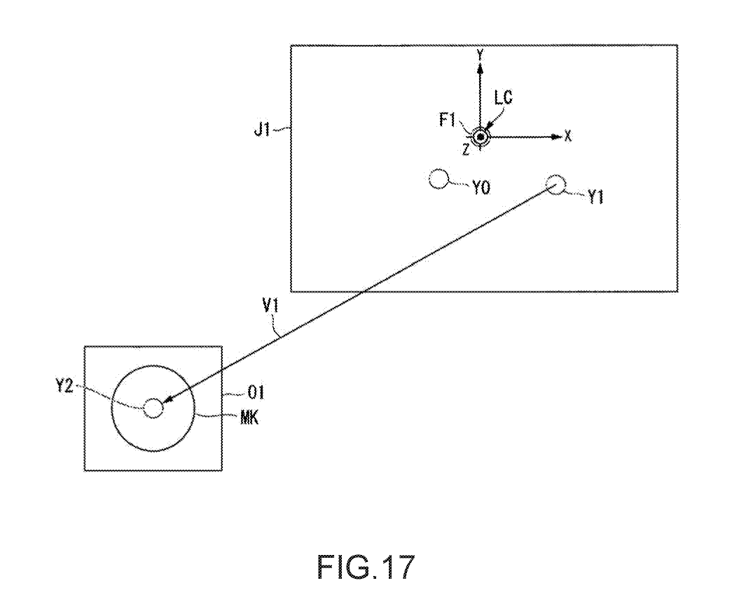

Herein, the processing of Step S250 to Step S310 will be described with reference to FIG. 17.

FIG. 17 is a view illustrating an example of a case where the upper surface of the jig J1 on which the droplet F1 is discharged and the upper surface of the target object O1 are seen from up to down. A position Y0 illustrated in FIG. 17 represents the in-plane position of the control point T1 in Step S280. A position Y1 illustrated in FIG. 17 represents the in-plane position of the tip portion NE in Step S280. In addition, a position Y2 illustrated in FIG. 17 represents an in-plane position of the position indicated by the marker MK.

In Step S250 and Step S260, the robot control unit 43 discharges the droplet F1 onto the upper surface of the jig J1 as illustrated in FIG. 17. Then, the control unit 36 acquires the captured image of the area that includes the droplet F1 illustrated in FIG. 17, which is the image captured by the second position detector 22, from the second position detector 22 by the processing of Step S270 to Step S277.

After the captured image of the area that includes the droplet F1 is acquired from the second position detector 22, the position detection unit 45 calculates the in-plane position of the droplet F1 and a relative position between the position Y1, which is the in-plane position of the tip portion NE, and the position Y0, which is the in-plane position of the control point T1, in Step S280, and sets the reference coordinate system LC with respect to the in-plane position of the droplet F1 as illustrated in FIG. 17 in Step S290. The position detection unit 45 newly indicates (recalculates) the position Y1, which is the in-plane position of the tip portion NE, as a position in the reference coordinate system LC.

After the position Y1, which is the in-plane position of the tip portion NE, is newly indicated as the position in the reference coordinate system LC, by the processing of Step S300 to Step S307, the position detection unit 45 acquires, from the second position detector 22, the image captured by the second position detector 22, which is the captured image of the area that includes the upper surface of the target object O1 illustrated in FIG. 17, that is, the area that includes the marker MK.

After the captured image of the area that includes the marker MK is acquired from the second position detector 22, the position detection unit 45 newly indicates (recalculates), the position Y2, which is the in-plane position indicated by the marker MK, as the position indicated by the marker MK in the reference coordinate system LC in Step S310 based on the position indicated by the marker MK on the captured image and the in-plane position of the control point T1 in Step S310. Then, the position detection unit 45 calculates the vector V1 indicating displacement from the position of the tip portion NE in the reference coordinate system LC to the position indicated by the marker MK in the reference coordinate system LC, as illustrated in FIG. 17.

After the vector V1 is calculated in Step S310, the robot control unit 43 moves the control point T1 based on the calculated vector V1 in Step S310, and has the in-plane position of the tip portion NE coincide with the position indicated by the marker MK in the reference coordinate system LC (Step S320). Next, the robot control unit 43 discharges the adhesive which is put in the syringe portion H1 from the tip portion NE of the needle portion N1 to a position on the upper surface of the target object O1, which is the position indicated by the marker MK, by injecting air within the syringe portion H1 (Step S330), and terminates processing.

As described above, the robot control device 30 causes the robot 10 to perform a predetermined work. Instead of a configuration in which the droplet F1 of the adhesive is discharged onto the upper surface of the jig J1, the robot control device 30 may have other configurations in which a plus (+) shape is drawn onto the upper surface with the adhesive by the dispenser D1, when causing the robot 10 to perform the trial discharging in Step S260. In this case, the robot control device 30 in Step S280 detects a position on the captured image of the plus shape included in the captured image instead of a position on the captured image of the droplet F1 included in the captured image. The position of the plus shape is, for example, represented by a position of a point of intersection at which two straight lines of the plus shape intersects. In addition, when the robot 10 is caused to perform the trial discharging in Step S260, the robot control device 30 may have a configuration in which the tip portion NE presses pressure-sensitive paper provided on the upper surface of the jig J1 instead of a configuration in which the droplet F1 of the adhesive is discharged onto the upper surface of the jig J1. In this case, the robot control device 30 detects positions of tracks left by the tip portion NE pressing the pressure-sensitive paper, instead of the position on the captured image of the droplet F1 included in the captured image in Step S280.

In addition, the robot control device 30 may perform the processing of Step S210 to Step S290 each time the robot control device 30 causes the robot 10 to perform a predetermined work, or each time a predetermined determination condition, including the occurrence of a defect in the target object O1 to which the adhesive is discharged, is satisfied after a predetermined work is performed, or based on an operation received from a user. Other examples of the determination condition include exchanging the dispenser D1 and the needle portion N1 coming into contact with other objects.

As described above, the robot 10 in the embodiment detects the position of the discharging unit (in this example, the dispenser D1) by means of the position detector (in this example, at least any one of the first position detector 21 and second position detector 22), and moves the discharging unit by means of the movement unit (in this example, the arm A) based on the detected result. Accordingly, the robot 10 can perform the work of discharging the liquid (in this example, the adhesive) to the target object (in this example, the target object O1) with high accuracy even in a case where the position of the discharging unit is shifted.

In addition, the robot 10 detects the position of the discharging unit, which is capable of being attached and detached with respect to the movement unit, by means of the position detector, and moves the discharging unit by means of the movement unit based on the detected result. Accordingly, the robot 10 can perform the work of discharging the liquid to the target object with high accuracy even in a case where the position of the discharging unit which is capable of being attached and detached with respect to the movement unit is shifted.

In addition, the robot 10 detects the position of the discharging unit which is capable of being attached and detached with respect to the movement unit by means of a contact sensor, and moves the discharging unit by means of the movement unit based on the detected result. Accordingly, the robot 10 can perform the work of discharging the liquid to the target object with high accuracy based on the position of the discharging unit, which is the position detected by the contact sensor, even in a case where the position of the discharging unit is shifted.

In addition, the robot 10 detects the position of the discharging unit which is capable of being attached and detached with respect to the movement unit by means of a laser sensor, and moves the discharging unit by means of the movement unit based on the detected result. Accordingly, the robot 10 can perform the work of discharging the liquid to the target object with high accuracy based on the position of the discharging unit, which is the position detected by the laser sensor, even in a case where the position of the discharging unit is shifted.

In addition, the robot 10 detects the position of the discharging unit which is capable of being attached and detached with respect to the movement unit by means of a force sensor, and moves the discharging unit by means of the movement unit based on the detected result. Accordingly, the robot 10 can perform the work of discharging the liquid to the target object with high accuracy based on the position of the discharging unit, which is the position detected by the force sensor, even in a case where the position of the discharging unit is shifted.

In addition, the robot 10 detects the position of the discharging unit which is capable of being attached and detached with respect to the movement unit by means of the imaging unit (in this example, the second position detector 22), and moves the discharging unit by means of the movement unit based on the detected result. Accordingly, the robot 10 can perform the work of discharging the liquid to the target object with high accuracy based on the position of the discharging unit, which is the position detected by the imaging unit, even in a case where the position of the discharging unit is shifted.

In addition, the robot 10 moves the discharging unit by means of the movement unit based on the first image of the liquid discharged by the discharging unit captured by the imaging unit. Accordingly, the robot 10 can perform the work of discharging the liquid to the target object with high accuracy based on the first image (in this example, the captured image of the area that includes the droplet F1 captured by the second position detector 22) even in a case where the position of the discharging unit is shifted.

In addition, the robot 10 moves the discharging unit by means of the movement unit based on the position of the liquid included in the first image. Accordingly, the robot 10 can perform the work of discharging the liquid to the target object with high accuracy based on the position of the liquid included in the first image even in a case where the position of the discharging unit is shifted.

In addition, the robot 10 moves the discharging unit by means of the movement unit based on one or more trial discharging points included in the first image. Accordingly, the robot 10 can perform the work of discharging the liquid to the target object with high accuracy based on one or more trial discharging points included in the first image even in a case where the position of the discharging unit is shifted.

In addition, the marker (in this example, the marker MK) is provided in the discharging target (in this example, the target object O1) to which the liquid is discharged, and the robot 10 moves the discharging unit by means of the movement unit based on the second image (in this example, the captured image of the area that includes the marker MK captured by the second position detector 22) of the marker captured by the imaging unit. Accordingly, the robot 10 can perform the work of discharging the liquid to the target object with high accuracy based on the first image and the second image even in a case where the position of the discharging unit is shifted.

In addition, the robot 10 moves the discharging unit by means of the movement unit based on the position of the marker included in the second image. Accordingly, the robot 10 can perform the work of discharging the liquid to the target object with high accuracy based on the position of the marker included in the first image and the second image even in a case where the position of the discharging unit is shifted.

In addition, the robot 10 detects position of the discharging unit which is capable of being attached and detached with respect to the movement unit by means of the imaging unit provided in the movement unit, and moves the discharging unit by means of the movement unit based on the detected result. Accordingly, the robot 10 can perform the work of discharging the liquid to the target object with high accuracy based on the position of the discharging unit, which is the position detected by the imaging unit provided in the movement unit, even in a case where the position of the discharging unit is shifted.

In addition, the robot 10 detects the position of the discharging unit which discharges the adhesive by means of the position detector, and moves the discharging unit by means of the movement unit based on the detected result. Accordingly, the robot 10 can perform the work of discharging the adhesive to the target object with high accuracy even in a case where the position of the discharging unit is shifted.

### Third Embodiment

Hereinafter, a third embodiment of the invention will be described with reference to the drawings.

### Configuration of Robot System

First, a configuration of a robot system 3 will be described.

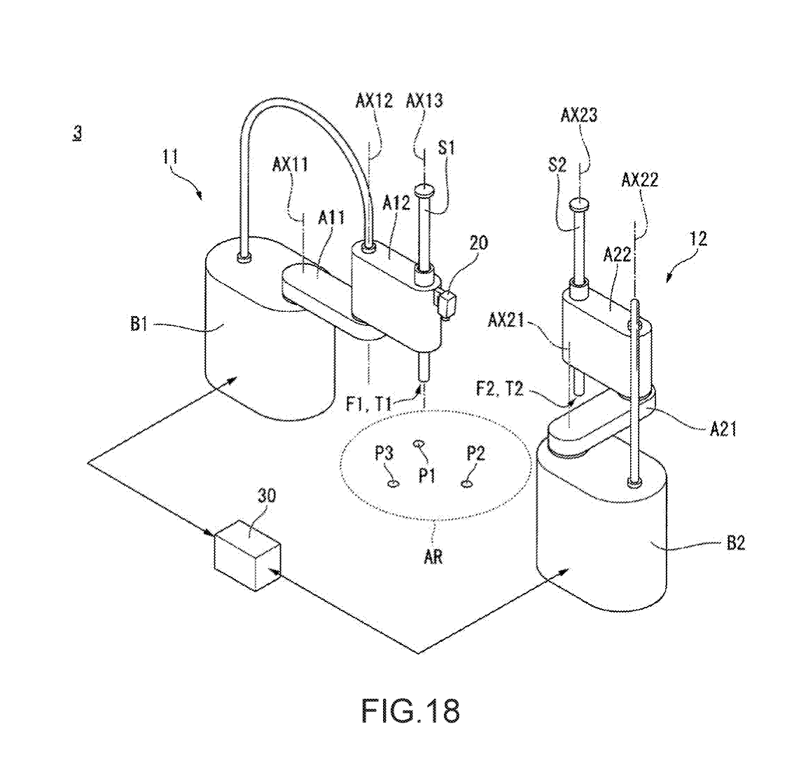

FIG. 18 is a view illustrating an example of the configuration of the robot system 3 according to the embodiment.

The robot system 3 of the embodiment is different from that of the first embodiment in that the robot system 3 includes a first robot 11 and second robot 12. Hereinafter, the same reference numerals will be assigned to configuration members which are the same as that of the first embodiment, and description thereof will be omitted or simplified herein.

As illustrated in FIG. 18, the robot system 3 of the embodiment includes the first robot 11, the second robot 12, and the control device (robot control device) 30.

The first robot 11 is a SCARA. Instead of the SCARA, the first robot 11 may be other robots including a cartesian coordinate robot, a one-armed robot, and two-armed robot. The cartesian coordinate robot is, for example, a gantry robot.

In an example illustrated in FIG. 18, the first robot 11 is provided on a floor. Instead of the floor, the first robot 11 may be configured to be provided on a wall or a ceiling, a table or a jig, an upper surface of a base, and the like. Hereinafter, a direction orthogonal to a surface on which the first robot 11 is provided, that is a direction from the first robot 11 to this surface will be referred to as down, and a direction opposite to this direction will be referred to as up for the convenience of description. The direction orthogonal to the surface on which the first robot 11 is provided, that is the direction from the center of the first robot 11 to this surface is, for example, a negative direction of the Z-axis in the world coordinate system or is a negative direction of the Z-axis in a robot coordinate system RC of the first robot 11.

The first robot 11 includes the support base B1 that is provided on the floor, the first arm A11 supported by the support base B1 so as to be capable of rotating about a first axis AX11, the second arm A12 supported by the first arm A11 so as to be capable of rotating about a second axis AX12, and the shaft S1 supported by the second arm A12 so as to be capable of rotating about a third axis AX13 and so as to be capable of translating in a third axis AX13 direction.

The shaft S1 is a cylindrical shaft. Each of a ball screw groove (not illustrated) and a spline groove (not illustrated) is formed in an external peripheral surface of the shaft S1. The shaft S1 is provided so as to penetrate an end portion on a side opposite to the first arm A11 in the up-and-down direction, out of end portions of the second arm A12. In addition, in the shaft S1, a discoid flange that has a radius larger than the radius of the cylinder is provided on an upper end portion out of end portions of the shaft S1, in this example. The central axis of the cylinder coincides with the central axis of the flange.

On an end portion in which the flange of the shaft S1 is not provided, the first work portion F1 to which the end effector can be attached is provided. Hereinafter, a case where the shape of the first work portion F1, when the first work portion F1 is seen from down to up, is a circle of which the center coincides with the central axis of the shaft S1 will be described as an example. The shape may be other shapes instead of the circle.

The control point T1 that is the TCP moving along with the first work portion F1 is set at the position of the first work portion F1. The position of the first work portion F1 is a position of the center of the circle, which is the shape of the first work portion F1 in a case where the first work portion F1 seen from down to up. The position at which the control point T1 is set may be other positions correlated with the first work portion F1, instead of the position of the first work portion F1. In this example, the position of the center of the circle represents the position of the first work portion F1. Instead of the aforementioned position, a configuration in which the position of the first work portion F1 is represented by other positions may be adopted.

The control point coordinate system TC1 that is the three-dimensional local coordinate system representing the position and posture of the control point T1 (that is, the position and posture of the first work portion F1) is set on the control point T1. The position and posture of the control point T1 correspond to the position and posture in a first robot coordinate system RC1 of the control point T1. The first robot coordinate system RC1 is the robot coordinate system of the first robot 11. The original of the control point coordinate system TC1 represents the position of the control point T1, that is, the position of the first work portion F1. In addition, a direction of each of the coordinate axes of the control point coordinate system TC1 represents the posture of the control point T1, that is, the posture of the first work portion F1. Hereinafter, a case where the Z-axis in the control point coordinate system TC1 coincides with the central axis of the shaft S1 will be described as an example. The Z-axis in the control point coordinate system TC1 is not necessarily required to coincide with the central axis of the shaft S1.

Each of the actuators and the imaging unit 20 included in the first robot 11 are connected to the control device 30 via a cable so as to be capable of communicating with the control device 30. Accordingly, each of the actuators and the imaging unit 20 operates based on a control signal acquired from the control device 30. Wired communication via the cable is, for example, carried out in accordance with standards including Ethernet (registered trademark) and USB. In addition, a part or the whole of the actuators and the imaging unit 20 may be configured to be connected to the control device 30 by wireless communication carried out in accordance with communication standards including Wi-Fi (registered trademark).

The second robot 12 is a SCARA. Instead of the SCARA, the second robot 12 may be other robots including a cartesian coordinate robot, a one-armed robot, and a two-armed robot.

In an example illustrated in FIG. 18, the second robot 12 is provided on the floor where the first robot 11 is provided but at a position different from the position at which the first robot 11 is provided. In addition, the second robot 12 is provided at a position where a work can be performed in a region AR, illustrated in FIG. 18, which includes a region in which the first robot 11 can perform a work. Instead of the floor, the second robot 12 may be configured to be provided on a wall or a ceiling, a table or a jig, an upper surface of a base and the like.

The second robot 12 includes a support base B2 that is provided on the floor, a first arm A21 supported by the support base B2 so as to be capable of rotating about a first axis AX21, a second arm A22 supported by the first arm A21 so as to be capable of rotating about a second axis AX22, and a shaft S2 supported by the second arm A22 so as to be capable of rotating about a third axis AX23 and so as to be capable of translating in a third axis AX23 direction.

The shaft S2 is a cylindrical shaft. Each of a ball screw groove (not illustrated) and a spline groove (not illustrated) is formed in an external peripheral surface of the shaft S2. The shaft S2 is provided so as to penetrate, in an up-and-down direction, an end portion on a side opposite to the first arm A21, out of end portions of the second arm A22. In addition, a discoid flange that has a radius larger than the radius of the cylinder is provided on an upper end of the shaft S2 out of end portions of the shaft S2, in this example. The central axis of the cylinder coincides with the central axis of the flange.

On an end portion, on which the flange of the shaft S2 is not provided, a second work portion F2 to which an end effector can be attached is provided. Hereinafter, a case where a shape of the second work portion F2, when the second work portion F2 is seen from down to up, is a circle of which the center coincides with the central axis of the shaft S2 will be described as an example. The shape may be other shapes instead of the circle.

A control point T2 that is a TCP moving along with the second work portion F2 is set at the position of the second work portion F2. The position of the second work portion F2 is a position of the center of the circle, which is the shape of the second work portion F2 in a case where the second work portion F2 is seen from down to up. The position at which the control point T2 is set may be other positions correlated with the second work portion F2, instead of the position of the second work portion F2. In this example, the position of the center of the circle represents the position of the second work portion F2. Instead of the aforementioned position, a configuration in which the position of the second work portion F2 is represented by other positions may be adopted.

A control point coordinate system TC2 that is a three-dimensional local coordinate system representing the position and posture of the control point T2 (that is, the position and posture of the second work portion F2) is set on the control point T2. The position and posture of the control point T2 correspond to the position and posture in the second robot coordinate system RC2 of the control point 12. The second robot coordinate system RC2 is a robot coordinate system of the second robot 12. The original of the control point coordinate system TC2 represents the position of the control point T2, that is, the position of the second work portion F2. In addition, a direction of each of the coordinate axes of the control point coordinate system TC2 represents the posture of the control point T2, that is, the posture of the second work portion F2. Hereinafter, a case where the Z-axis in the control point coordinate system TC2 coincides with the central axis of the shaft S2 will be described as an example. The Z-axis in the control point coordinate system TC2 does not necessarily have to coincide with the central axis of the shaft S2.

The first arm A21 moves in the horizontal direction since the first arm A21 rotates about the first axis AX21. In this example, the horizontal direction is a direction orthogonal to the up-and-down direction. The horizontal direction is, for example, a direction along the XY plane in the world coordinate system or a direction along the XY plane in the second robot coordinate system RC2 that is the robot coordinate system of the second robot 12.

The second arm A22 moves in the horizontal direction since the second arm A22 rotates about the second axis AX22. The second arm A22 includes a vertical motion actuator (not illustrated) and a rotating actuator (not illustrated), and supports the shaft S2. The vertical motion actuator moves (lifts up and down) the shaft S2 in the up-and-down direction by rotating, with a timing belt or the like, a ball screw nut provided in an outer peripheral portion of the ball screw groove of the shaft S2. The rotating actuator rotates the shaft S2 about the central axis of the shaft S2 by rotating, with the timing belt or the like, a ball spline nut provided in an outer peripheral portion of the spline groove of the shaft S2.

Each of the actuators included in the second robot 12 is connected to the control device 30 via a cable so as to be capable of communicating with the control device 30. Accordingly, each of the actuators operates based on a control signal acquired from the control device 30. Wired communication via the cable is, for example, carried out in accordance with standards including Ethernet (registered trademark) and USB. In addition, a part or the whole of the actuators may be configured to be connected to the control device 30 by wireless communication carried out in accordance with communication standards including Wi-Fi (registered trademark).

The control device 30 operates the first robot 11 by transmitting the control signal to the first robot 11. Accordingly, the control device 30 causes the first robot 11 to perform a first work that is a predetermined work. In addition, the control device 30 operates the second robot 12 by transmitting a control signal to the second robot 12. Accordingly, the control device 30 causes the second robot 12 to perform a second work which is a predetermined work different from the first work. That is, the control device 30 is a control device that controls two robots including the first robot 11 and the second robot 12. Instead of two robots, the control device 30 may be configured to control three or more robots. In addition, instead of being configured to be provided outside the first robot 11 and the second robot 12, the control device 30 may be configured to be mounted in anyone of the first robot 11 and the second robot 12.

### Outline of Calibrating First Robot, Second Robot and Control Device

Hereinafter, an outline of calibrating the first robot 11, the second robot 12, and the control device 30 will be described in this example.

The control device 30 causes the first robot 11 to perform the first work and causes the second robot 12 to perform the second work based on the image captured by the imaging unit 20. At this time, a position indicated by each coordinate in an imaging unit coordinate system CC and a position indicated by each coordinate in the first robot coordinate system RC1 are required to be correlated with each other by calibration in order for the control device 30 to cause the first robot 11 to perform the first work. The imaging unit coordinate system CC is a coordinate system representing a position on the image captured by the imaging unit 20. In addition, the position indicated by each coordinate in the imaging unit coordinate system CC and a position indicated by each coordinate in the second robot coordinate system RC2 are required to be correlated with each other by calibration in order for the control device 30 to cause the second robot 12 to perform the second work with high accuracy.

In a control device X (for example, the control device of the related art) which is different from the control device 30, it is impossible or difficult to perform double calibration, which is the calibration in which the position indicated by each coordinate in the imaging unit coordinate system CC is correlated with the position indicated by each coordinate in the first robot coordinate system RC1, and the position indicated by each coordinate in the imaging unit coordinate system CC is correlated with the position indicated by each coordinate in the second robot coordinate system RC2. The term double calibration is a term to differentiate the calibration in the embodiment from other calibration for the convenience of description.

For the above reason, in the control device X, a position indicated by each coordinate in an imaging unit coordinate system X1C that is a coordinate system representing a position on a captured image X11 and the position indicated by each coordinate in the first robot coordinate system RC1 are correlated with each other by calibration, and a position indicated by each coordinate in an imaging unit coordinate system X2C that is a coordinate system representing a position on a captured image X21 and the position indicated by each coordinate in the second robot coordinate system RC2 are correlated with each other by calibration. The captured image X11 is an image captured by an imaging unit X1 corresponding to the first robot 11. The captured image X21 is an image captured by an imaging unit X2 corresponding to the second robot 12. The imaging unit X2 is an imaging unit other than the imaging unit X1.

In this case, the control device X can cause the first robot 11 to perform the first work with high accuracy based on the captured image X11, and cause the second robot 12 to perform the second work with high accuracy based on the captured image X21. Even in this case, however, it is difficult for the control device X to perform a cooperation work with high accuracy, for example, in a case where the first robot 11 and the second robot 12 perform the first work and the second work as the cooperation work unless the position indicated by each coordinate in the first robot coordinate system RC1 and the position indicated by each coordinate in the second robot coordinate system RC2 are correlated with each other by mechanical calibration. In this example, the mechanical calibration is adjusting a relative position and posture between a plurality of robots by each of positions at which the plurality of robots are provided being adjusted (changed).

The cooperation work is a work with respect to one or more positions correlated in the world coordinate system performed by two or more robots, and includes, for example, a case where the first work of gripping a target object O is performed by the first robot 11 and the second work of polishing the target object O gripped by the first robot 11 in the first work is performed by the second robot 12. The one or more positions include, for example, a position having the same coordinate in the world coordinate system and a plurality of positions of which a relative position in the world coordinate system is determined.

On the other hand, the control device 30 can carry out double calibration as described above. For this reason, the control device 30 can cause the first robot 11 to perform the first work with high accuracy and can cause the second robot 12 to perform the second work with high accuracy based on the image captured by one imaging unit 20 without two imaging units, including the imaging unit X1 and the imaging unit X2, being prepared. Accordingly, the control device 30 can restrict monetary costs incurred by causing a plurality of robots to perform works and can reduce time and effort required for providing a plurality of imaging units without the imaging units as many as the number of robots controlled by the control device 30 being required to be prepared.

In addition, the control device 30 can easily cause the first robot 11 and the second robot 12 to perform the cooperation work based on an image of the first robot and the second robot captured by one imaging unit without mechanical calibration being carried out since the position indicated by each coordinate in the first robot coordinate system RC1 and the position indicated by each coordinate in the second robot coordinate system RC2 are correlated with each other by double calibration with the position indicated by each coordinate in the imaging unit coordinate system CC being used as a medium.

In the example illustrated in FIG. 18, the control device 30 causes the imaging unit 20 to image three reference points, including a reference point P1 to a reference point P3, provided within the aforementioned region AR. Each of the reference point P1 to the reference point P3 may be, for example, a tip of a protrusion, and may be an object or a marker. The marker may be a part of the object, and may be a mark provided in the object. The control device 30 carries out double calibration based on the image captured by the imaging unit 20. Hereinafter, processing in which the control device 30 carries out double calibration will be described. In addition, hereinafter, processing where the control device 30, in which double calibration is carried out, causes the first robot 11 to perform the first work and causes the second robot 12 to perform the second work will be described.

### Hardware Configuration of Control Device

Hereinafter, a hardware configuration of the control device 30 will be described with reference to FIG. 4. The control device 30 communicates with the first robot 11 and the second robot 12 via the communication unit 34.

### Functional Configuration of Control Device

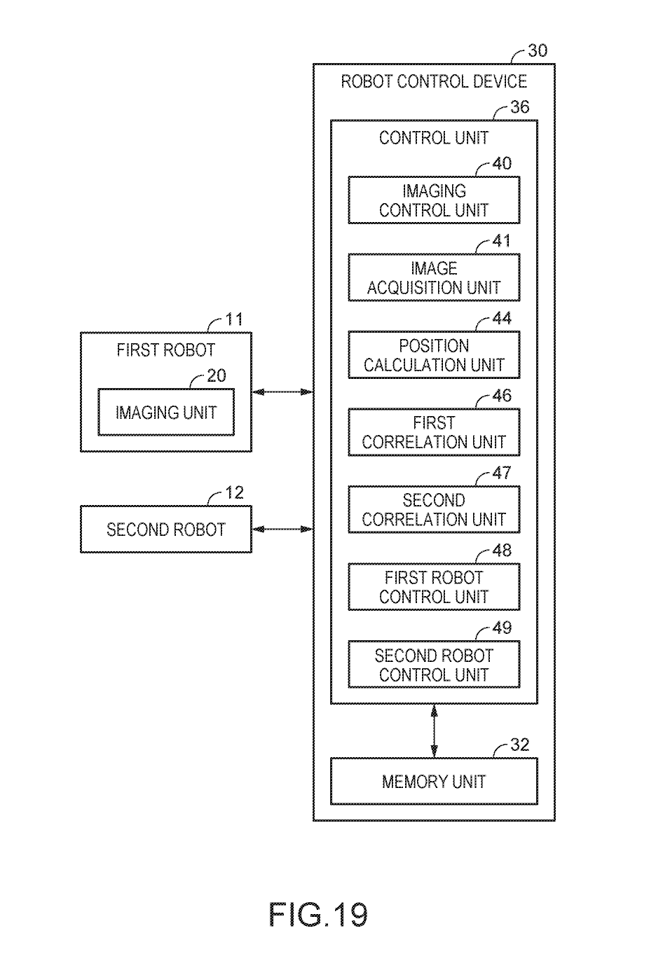

Hereinafter, a functional configuration of the control device 30 will be described with reference to FIG. 19.

FIG. 19 is a view illustrating an example of the functional configuration of the control device 30. The control device 30 includes the memory unit 32 and the control unit 36.

The control unit 36 controls the entire control device 30. The control unit 36 includes the imaging control unit 40, the image acquisition unit 41, a position calculation unit 44, a first correlation unit 46, a second correlation unit 47, a first robot control unit 48, and a second robot control unit 49. The functions of the aforementioned functional units included in the control unit 36 are realized, for example, by various programs stored in the memory unit 32 being executed by the CPU 31. In addition, a part or the whole of the functional units may be a hardware functional unit including an LSI and an ASIC.

The imaging control unit 40 causes the imaging unit 20 to image an area that can be imaged by the imaging unit 20. In this example, an imaging area is an area that includes the region AR.

The image acquisition unit 41 acquires the image captured by the imaging unit 20 from imaging unit 20.

The position calculation unit 44 calculates a position of the object or the marker included in the captured image based on the captured image acquired by the image acquisition unit 41. The position calculation unit 44 may be configured to calculate the position and posture of the object or the marker included in the captured image based on the captured image.

The first correlation unit 46 correlates the position indicated by each coordinate in the imaging unit coordinate system CC with the position indicated by each coordinate in the first robot coordinate system RC1 based on the captured image acquired by the image acquisition unit 41.

The second correlation unit 47 correlates the position indicated by each coordinate in the imaging unit coordinate system CC with the position indicated by each coordinate in the second robot coordinate system RC2 based on the captured image acquired by the image acquisition unit 41.

The first robot control unit 48 operates the first robot 11 based on the position calculated by the position calculation unit 44.

The second robot control unit 49 operates the second robot 12 based on the position calculated by the position calculation unit 44.

Processing in which Control Device Carries Out Double Calibration

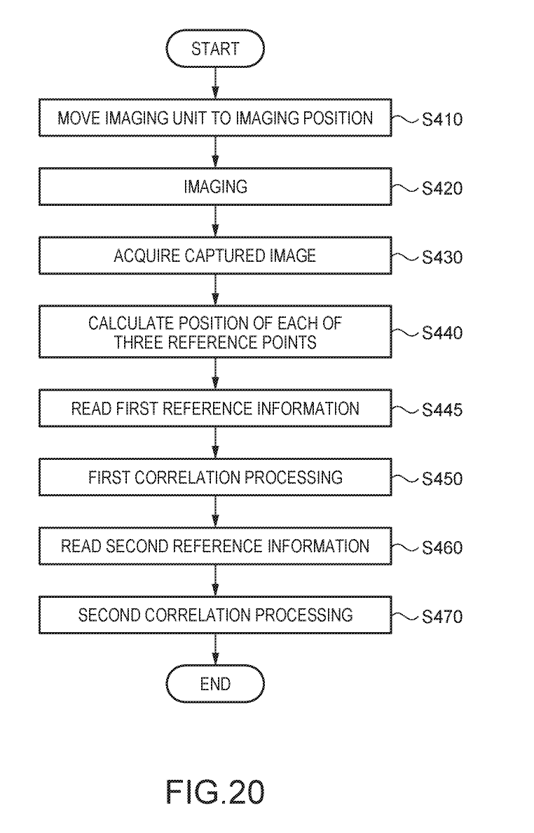

Hereinafter, the processing in which the control device 30 carries out double calibration will be described with reference to FIG. 20.

FIG. 20 is a flow chart illustrating an example of the flow of processing in which the control device 30 carries out double calibration.

Hereinafter, a case where a two-dimensional position in the imaging unit coordinate system CC and a two-dimensional position in the first robot coordinate system RC1 are correlated with each other and the two-dimensional position in the imaging unit coordinate system CC and a two-dimensional position in the second robot coordinate system RC2 are correlated with each other by double calibration carried out by the control device 30 will be described as an example. The two-dimensional position is a position indicated by an X-coordinate and a Y-coordinate in the two- or more-dimensional coordinate system. In this case, the imaging unit 20 may be a monocular camera, may be a stereo camera, and may be a light field camera.

The control device 30 may have a configuration in which a three-dimensional position in the imaging unit coordinate system CC and a three-dimensional position in the first robot coordinate system RC1 are correlated with each other and the three-dimensional position in the imaging unit coordinate system CC and a three-dimensional position in the second robot coordinate system RC2 are correlated with each other by double calibration. The three-dimensional position is a position indicated by each of an X-coordinate, a Y-coordinate, and a Z-coordinate in the three- or more-dimensional coordinate system. In this case, the imaging unit 20 may be a stereo camera, and may be a light field camera.

In this example, the control device 30 starts the processing of the flow chart illustrated in FIG. 20 by receiving an operation of switching to a double calibration mode as an operation mode via the input receiving unit 33.

After the operation mode is switched to the double calibration mode, the first robot control unit 48 reads imaging unit information stored in the memory unit 32 in advance from the memory unit 32. The imaging unit information is information indicating a relative position and posture between the position and posture of the control point T1 and the position and posture of the imaging unit 20. In addition, the first robot control unit 48 reads imaging position and posture information stored in the memory unit 32 in advance from the memory unit 32. The imaging position and posture information is information indicating a predetermined imaging position and imaging posture. The imaging position is a position with which the position of the imaging unit 20 is caused to coincide, and may be any position insofar as the area that includes the region AR can be imaged at the position. The imaging posture is a posture with which the posture of the imaging unit 20 in the imaging position is caused to coincide, and may be any posture insofar as the area that includes the region AR can be imaged in the posture. The first robot control unit 48 moves the control point T1, and has the imaging position and the imaging posture indicated by the imaging position and posture information coincide with the position and posture of the imaging unit 20 based on the read imaging unit information and the imaging position and posture information (Step S410).

Next, the imaging control unit 40 causes the imaging unit 20 to image the area that includes the region AR (Step S420). Next, the image acquisition unit 41 acquires the image captured by the imaging unit 20 in Step S420 from the imaging unit 20 (Step S430). As described above, each of the reference point P1 to the reference point P3 is provided in the region AR. For this reason, each of the reference point P1 to the reference point P3 is included (captured) in the captured image.

Next, the position calculation unit 44 calculates a position in the imaging unit coordinate system CC of each of the reference point P1 to the reference point P3, for example, by pattern matching or the like based on the captured image acquired by the image acquisition unit 41 in Step S430 (Step S440). As in the aforementioned description, in this example, this position is a two-dimensional position in the imaging unit coordinate system CC.

Next, the first correlation unit 46 reads first reference information from the memory unit 32 (Step S445). The first reference information is information indicating a position in the first robot coordinate system RC1 of each of the reference point P1 to the reference point P3 stored in the memory unit 32 in advance. In addition, the first reference information is information stored in the memory unit 32 in advance by an instruction through online teaching and an instruction through direct teaching.

The instruction through online teaching is moving the TCP of the robot to an intended position by means of a jog key provided in the control device 30 or a teaching pendant, and storing, in the control device 30, the position and posture in the first robot coordinate system RC1 of the TCP which is at the intended position. This robot is the first robot 11 or the second robot 12 in this example. The control device 30 can calculate the position and posture of the TCP based on forward kinematics. The instruction through direct teaching is manually moving the TCP of the robot to an intended position by the user, and storing, in the control device 30, the position and posture in the first robot coordinate system RC1 of the TCP which is at the intended position.

For example, in a case where the first reference information is stored by the instruction through direct teaching, the user manually moves the shaft S1, and stores information indicating the current position in the first robot coordinate system RC1 of the control point T1 as the first reference information in the memory unit 32 each time the control point T1 is caused to coincide with a position of each of the reference point P1 to the reference point P3. As in the aforementioned description, in this example, each position indicated by the first reference information is a two-dimensional position in the first robot coordinate system RC1.

After the first reference information is read from the memory unit 32 in Step S445, the first correlation unit 46 performs first correlation processing in which a position indicated by each coordinate in the first robot coordinate system RC1 and a position indicated by each coordinate in the imaging unit coordinate system CC are correlated with each other based on the position in the first robot coordinate system RC1 of each of the reference point P1 to the reference point P3, which is the position indicated by the read first reference information and the position in the imaging unit coordinate system CC of each of the reference point P1 to the reference point P3, which is the position calculated by the position calculation unit 44 in Step S440 (Step S450).

Next, the second correlation unit 47 reads second reference information from the memory unit 32 (Step S460). The second reference information is information indicating a position in the second robot coordinate system RC2 of each of the reference point P1 to the reference point P3 stored in the memory unit 32 in advance. In addition, the second reference information is information stored in the memory unit 32 in advance by the instruction through online teaching or the instruction through direct teaching.

For example, in a case where the second reference information is stored by the instruction through direct teaching, the user manually moves the shaft S2 and stores information indicating the current position in the second robot coordinate system RC2 of the control point T2 as the second reference information in the memory unit 32 each time the control point T2 is caused to coincide with a position of each of the reference point P1 to the reference point P3. As in the aforementioned description, in this example, each position indicated by the second reference information is a two-dimensional position in the second robot coordinate system RC2.

After the second reference information is read from the memory unit 32 in Step S460, the second correlation unit 47 performs second correlation processing in which a position indicated by each coordinate in the second robot coordinate system RC2 and the position indicated by each coordinate in the imaging unit coordinate system CC are correlated with each other based on a position in the second robot coordinate system RC2 of each of the reference point P1 to the reference point P3, which is a position indicated by the read second reference information and the position in the imaging unit coordinate system CC of each of the reference point P1 to the reference point P3, which is a position calculated by the position calculation unit 44 in Step S440 (Step S470).

As described above, the control device 30 performs the double calibration. The control device 30 may have a configuration in which the processing of Step S420 to Step S440 is performed again after the processing of Step S450 is performed and before the processing of Step S470 is performed. In addition, the control device 30 may have a configuration in which the processing of the flow chart illustrated in FIG. 20 is performed with the processing of Step S445 and Step S450 being interchanged with the processing of Step S460 and Step S470, and may have a configuration in which the above processing is performed in parallel. In addition, the reference points provided in the region AR may be two or more, and are not required to be three as in this example.

In addition, in this example, a case where the two-dimensional position in the imaging unit coordinate system CC and the two-dimensional position in the first robot coordinate system RC1 are correlated with each other, and the two-dimensional position in the imaging unit coordinate system CC and the two-dimensional position in the second robot coordinate system RC2 are correlated with each other by the control device 30 by means of double calibration has been described. Instead of this case, however, the control device 30 may have a configuration in which the two-dimensional position in the imaging unit coordinate system CC and the two-dimensional position in three or more robot coordinate systems are correlated with each other. The three or more robot coordinate systems are robot coordinate systems of each of three or more robots which are different from each other. In this case, the control device 30 controls each of the three or more robots.

In addition, the control device 30 may have a configuration in which each of two-dimensional positions of the imaging unit in the imaging unit coordinate system included in each combination and each of two-dimensional positions of the robot in the robot coordinate system included in each combination are correlated with each other for any combination of a part or the whole of M imaging units and a part or the whole of N robots. In this case, the control device 30 controls each of N robots. Herein, each of M and N is an integer which is equal to or greater than 1.

### Processing Performed by Control Device in First Work and Second Work

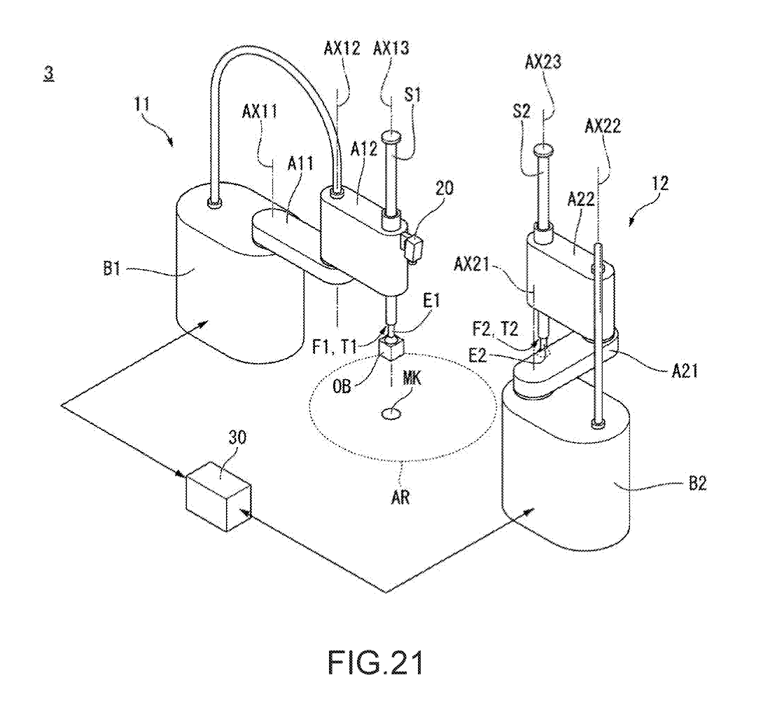

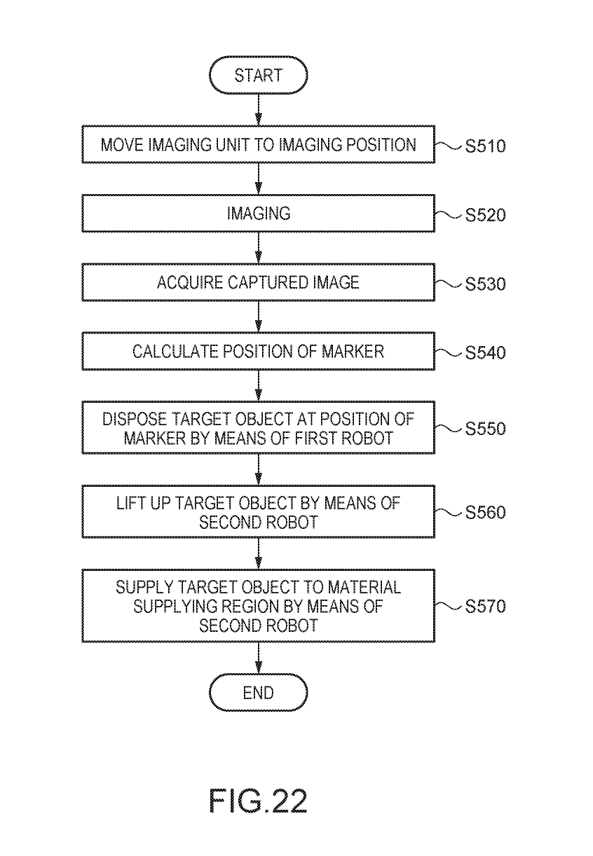

Hereinafter, processing performed by the control device in the first work and the second work will be described with reference to FIG. 21 and FIG. 22.

First, a configuration of the robot system 3 when the first work and the second work are performed will be described.

FIG. 21 is a view illustrating an example of the configuration of the robot system 3 when the first work and the second work are performed.

In an example illustrated in FIG. 21, the end effector E1 is attached to the first work portion F1 of the first robot 11. The end effector E1 is a vacuum gripper that is capable of adsorbing an object by sucking air. Instead of the vacuum gripper, the end effector E1 may be other end effectors including an end effector provided with a finger portion capable of gripping the object. In FIG. 21, the target object OB is lifted up by the end effector E1.

The target object OB is, for example, an industrial component or member and device. Instead of the aforementioned objects, the target object OB may be a non-industrial component or member for daily necessities and device, may be a medical component or member and device, and may be a living body such as a cell. In the example illustrated in FIG. 21, the target object OB is represented as a rectangular parallelepiped object. Instead of a rectangular parallelepiped shape, the shape of the target object OB may be other shapes.

In addition, in the example illustrated in FIG. 21, an end effector E2 is attached to the second work portion F2 of the second robot 12. The end effector E2 is a vacuum gripper that is capable of adsorbing an object by sucking air. Instead of the vacuum gripper, the end effector E2 may be other end effectors including an end effector provided with a finger portion capable of gripping the object.

Each of the reference point P1 to the reference point P3 is removed from the region AR illustrated in FIG. 21. In addition, in the region AR, the marker MK is provided at a predetermined disposition position within the region AR. The disposition position is a position at which the target object OB is disposed. The marker MK is a mark that indicates the disposition position.

In this example, the first robot 11 performs a work of disposing the target object OB lifted by in advance by the end effector E1 at the disposition position indicated by the marker MK as the first work. In addition, the second robot 12 performs a work of lifting up the target object OB disposed by the first robot 11 at the disposition position by means of the end effector E2 and supplying the target object OB to a predetermined material supplying region (not illustrated) as the second work.

Next, processing performed by the control device 30 in the first work and the second work will be described.

FIG. 22 is a flow chart illustrating an example of the flow of the processing performed by the control device 30 in the first work and the second work. The processing of the flow chart illustrated in FIG. 22 is processing after the target object OB is lifted up by the end effector E1. The control device 30 may be configured to cause the end effector E1 to lift up the target object OB in the first work.

The first robot control unit 48 reads the imaging unit information from the memory unit 32. In addition, the first robot control unit 48 reads the imaging position and posture information from the memory unit 32. Then, the first robot control unit 48 moves the control point T1, and has the imaging position and imaging posture indicated by the imaging position and posture information coincide with the position and posture of the imaging unit 20 based on the read imaging unit information and the imaging position and posture information (Step S510). In a case where the imaging unit information read from the memory unit 32 in Step S510 does not coincide with the imaging unit information read from the memory unit 32 when carrying out double calibration, the control device 30 is required to carry out double calibration again. In addition, in a case where the imaging position and posture information read from the memory unit 32 in Step S510 does not coincide with the imaging position and posture information read from the memory unit 32 when carrying out double calibration, the control device 30 is required to carry out double calibration again.

Next, the imaging control unit 40 causes the imaging unit 20 to image the area that includes the region AR (Step S520). Next, the image acquisition unit 41 acquires the image captured by the imaging unit 20 in Step S520 from the imaging unit 20 (Step S530). As described above, the marker MK is provided in the region AR. For this reason, the marker MK is included (captured) in the captured image. The captured image is an example of the first image.

Next, the position calculation unit 44 calculates, for example, a position in the first robot coordinate system RC1 of the marker MK by pattern matching or the like based on the captured image acquired by the image acquisition unit 41 in Step S530 (Step S540). As in the aforementioned description, in this example, this position is a two-dimensional position in the imaging unit coordinate system CC. The control device 30 can calculate a position in the first robot coordinate system RC1 of the marker MK based on such a captured image since the position indicating each coordinate in the imaging unit coordinate system CC and the position indicated by each coordinate in the first robot coordinate system RC1 are correlated with each other by double calibration.

Next, the first robot control unit 48 reads shape information stored in the memory unit 32 in advance from the memory unit 32. The shape information is information indicating a shape of each of the end effector E1 and the target object OB. In addition, the first robot control unit 48 reads the adsorption position information stored in the memory unit 32 in advance from the memory unit 32. The adsorption position information is information indicating a relative position from the position of the target object OB to a predetermined adsorption position at which the end effector E1 adsorbs, which is a position on a surface of the target object OB. In this example, the position of the target object OB is represented by a position of the center of a surface opposing a surface adsorbed by the end effector E1 out of surfaces of the target object OB. The first robot control unit 48 calculates a relative position between the control point T1 and the position of the target object OB based on the read shape information and the adsorption position information. The first robot control unit 48 moves the control point T1 and causes the position of the target object OB to coincide with the disposition position within the region AR based on the calculated position and the position calculated in Step S540. Accordingly, the first robot control unit 48 disposes the target object OB at the disposition position (Step S550). The first robot control unit 48 stores, in advance, a position of the marker MK disposed, by calibration, on the surface within the region AR, which is a position in the Z-axis direction in the first robot coordinate system RC1. The first robot control unit 48 moves the control point T1 to a predetermined standby position (not illustrated) after the target object OB is disposed at the disposition position. The predetermined standby position may be any position insofar as the second robot 12 does not come into contact with the first robot 11 at the position in a case where the second robot 12 performs the second work in the region AR.

Next, the second robot control unit 49 reads the shape information stored in the memory unit 32 in advance from the memory unit 32. In addition, the second robot control unit 49 reads the adsorption position stored in the memory unit 32 in advance from the memory unit 32. The second robot control unit 49 calculates a relative position between the control point T2 and the position of the target object OB in a case where the end effector E2 adsorbs the target object OB at the adsorption position of target object OB based on the read shape information and the adsorption position information. The second robot control unit 49 moves the control point T2, and adsorbs, by means of the end effector E2, at the adsorption position of the target object OB which is disposed at the disposition position within the region AR based on the calculated position and the position calculated in Step S540. Then, the second robot control unit 49 lifts up the target object OB (Step S560). The second robot control unit 49 stores, in advance, the position of the marker MK disposed on the surface within the region AR, which is a position in the Z-axis direction in the second robot coordinate system RC2 by calibration.

Next, the second robot control unit 49 reads material supplying region information stored in the memory unit 32 in advance. The material supplying region information is information indicating a position of the material supplying region (not illustrated). The second robot control unit 49 supplies the target object OB to the material supplying region based on the read material supplying region information (Step S570), and terminates processing.

The control device 30 may have a configuration in which the processing of Step S510 to Step S530 is performed again after the processing of Step S550 is performed and before the processing of Step S560 is performed, and a position in the second robot coordinate system RC2 of the target object OB disposed within the region AR is calculated based on a newly captured image. In this case, the control device 30 calculates, for example, this position by pattern matching or the like. Accordingly, the control device 30 can perform the second work with high accuracy even in a case where the position of the target object OB is shifted from the disposition position due to vibration in the first work. The captured image is an example of the second image.

As described above, the control device 30 operates the first robot 11 based on the image captured by the imaging unit 20 and the first robot coordinate system RC1, and operates the second robot 12 based on the second robot coordinate system RC2, which is different from the first robot coordinate system RC1, and the captured image. Accordingly, the control device 30 can easily operate the first robot 11 and the second robot 12 based on the image captured by one imaging unit 20 without mechanical calibration being carried out.

Modification Example of Processing in which Control Device Carries Out Double Calibration

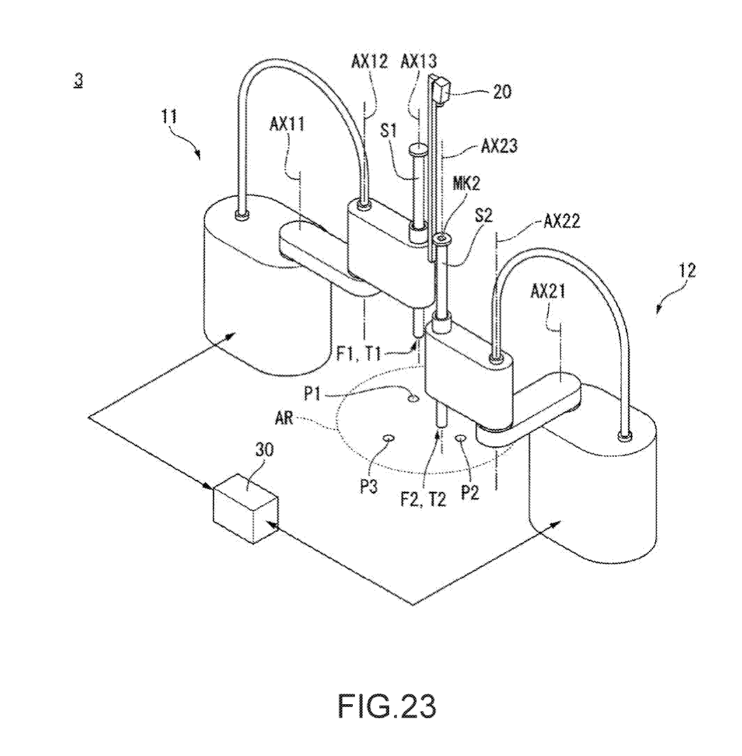

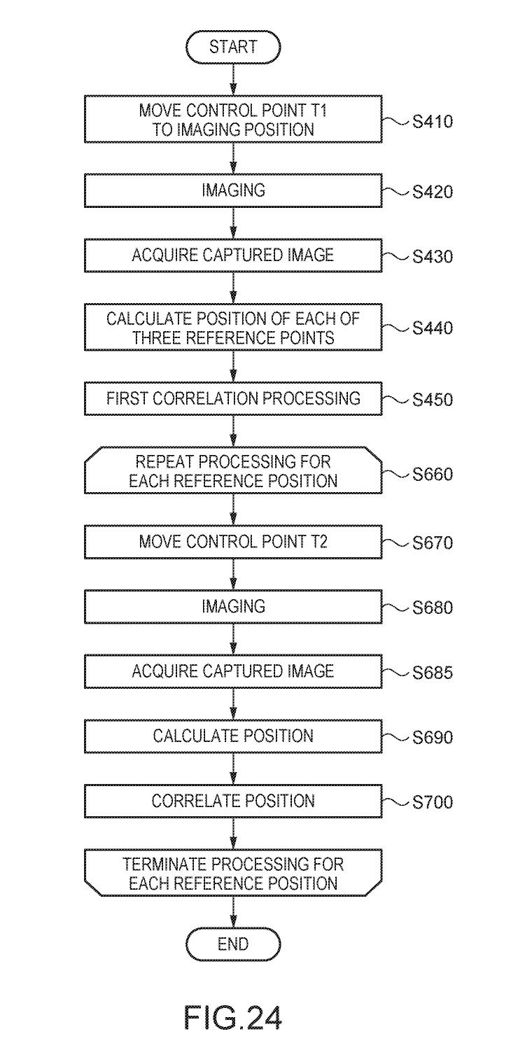

Hereinafter, a modification example of processing in which the control device 30 carries out double calibration will be described with reference to FIG. 23 and FIG. 24.

First, a configuration of the robot system 3 when the control device 30 carries out double calibration will be described.

FIG. 23 is a view illustrating an example of the configuration of the robot system 3 when the control device 30 carries out double calibration.

A position at which the imaging unit 20 is provided in the up-and-down direction in the configuration illustrated in FIG. 23 is higher than a position at which the imaging unit is provided in the up-and-down direction in the configuration illustrated in FIG. 18. More specifically, the imaging unit 20 is provided at a position where the area that includes the region AR can be imaged, which is a position at which the upper surface of the flange provided on an upper end portion of the shaft S2 can be further imaged. In addition, in this example, the marker MK2 is provided on the upper surface of the flange. The marker MK2 is a marker indicating the position of the control point T2. This position is a two-dimensional position in the world coordinate system. The marker MK2 may be any marker insofar as the marker indicates the position of the control point T2. The flange is an example of the target object moved by the second robot 12.

Next, the modification example of the processing in which the control device 30 carries out double calibration will be described.

FIG. 24 is a flow chart illustrating an example of the flow of the modification example of the processing in which the control device 30 carries out double calibration. Hereinafter, since the processing of Step S410 to Step S450 illustrated in FIG. 24 is similar to the processing of Step S410 to Step S450 illustrated in FIG. 20, except for a part of the processing, description will be omitted. The part of the processing refers to a part of the processing of Step S410. In the processing of Step S410 illustrated in FIG. 24, the control device 30 fixes the position and posture of the imaging unit 20 such that the position and posture do not change, after having the position and posture of the imaging unit 20 coincide with the imaging position and the imaging posture.

After the processing of Step S450 is performed, the control unit 36 repeats the processing of Step S670 to Step S700 for each of a plurality of reference positions (Step S660). The reference position is a position with which the control device 30 has the position of the control point T2 coincide in double calibration, and is a position within the region AR. Hereinafter, a case where there are three reference positions including a reference position P11 to a reference position P13 will be described as an example of the reference position. The reference positions may be two or more, and are not required to be three.

The second robot control unit 49 moves the control point T2, and has the position of the control point T2 coincide with the reference position (any one of the reference position P11 to the reference position P13) selected in Step S660 (Step S670). Next, the imaging control unit 40 causes the imaging unit 20 to image an area that includes the upper surface of the flange provided on the upper end portion of the shaft S2, which is the area that includes the region AR (Step S680). Next, the image acquisition unit 41 acquires the image captured by the imaging unit 20 in Step S680 from the imaging unit 20 (Step S685). As described above, the marker MK2 is provided on the upper surface of the flange. For this reason, the marker MK2 is included (captured) in the captured image.

Next, the position calculation unit 44 calculates a position indicated by the marker MK2, that is, a position of the control point T2 in the imaging unit coordinate system CC based on the captured image acquired by the image acquisition unit 41 in Step S685. In addition, the position calculation unit 44 calculates the current position of the control point T2 in the second robot coordinate system RC2 based on forward kinematics (Step S690). Next, the second correlation unit 47 correlates the position of the control point T2 in the imaging unit coordinate system CC with the position of the control point T2 in the second robot coordinate system RC2 that are calculated in Step S690 (Step S700).

As described above, the second correlation unit 47 correlates the position indicated by each coordinate in the imaging unit coordinate system CC with the position indicated by each coordinate in the second robot coordinate system RC2 by the processing of Step S670 to Step S700 being repeated for each reference position. After the processing of Step S670 to Step S700 is repeated for all of the reference positions, the second robot control unit 49 terminates processing.

As described above, the control device 30 carries out double calibration by a method different from the method described in FIG. 20. In the double calibration of this example, the marker MK2 may be configured to be provided at a part of the target object gripped or adsorbed by the end effector which is attached to the shaft S2. In this case, the control device 30 performs the processing of Step S690 using information indicating a relative position between the position of the control point T2 and the position of the marker MK2. The marker MK2 may be a part of the target object itself. In addition, in Step S690, the control device 30 may be configured to detect, by pattern matching or the like, the flange provided on the upper end portion of the shaft S2 instead of the marker MK2, and to calculate the position of the control point T2 in the imaging unit coordinate system CC based on the position of the flange. The position of the flange is the center of the upper surface of the flange. In this case, the control device 30 calculates the position of the control point T2 in the imaging unit coordinate system CC based on a relative position between the position of the flange and the position of the control point T2.

As described above, the control device 30 in the embodiment operates the first robot (in this example, the first robot 11) based on the first image captured by the imaging unit (in this example, the imaging unit 20) and the first robot coordinate system (in this example, the first robot coordinate system RC1), and operates the second robot (in this example, the second robot 12) based on second robot coordinate system (in this example, the second robot coordinate system RC2) which is different from the first robot coordinate system and the second image captured by the imaging unit. Accordingly, the control device 30 can operate the first robot and the second robot with high accuracy based on the image captured by one imaging unit without mechanical calibration being carried out.

In addition, the control device 30 operates the first robot based on the first image captured by the imaging unit and the first robot coordinate system, and operates the second robot based on the second robot coordinate system and the first image. Accordingly, the control device 30 can easily operate the first robot and the second robot based on the first image captured by one imaging unit without mechanical calibration being carried out.

In addition, the control device 30 operates the first robot based on the first image captured by the imaging unit provided in the first robot and the first robot coordinate system, and operates the second robot based on the second robot coordinate system and the second image captured by the imaging unit. Accordingly, the control device 30 can easily operate the first robot and the second robot based on the image captured by the imaging unit provided in the first robot without mechanical calibration being carried out.

In addition, the control device 30 correlates the first robot coordinate system with the imaging unit coordinate system of the imaging unit and correlates the second robot coordinate system with the imaging unit coordinate system, by moving the imaging unit. Accordingly, the control device 30 can operate the first robot with high accuracy based on the first image and the first robot coordinate system, and can operate the second robot with high accuracy based on the second image and the second robot coordinate system.

In addition, the control device 30 correlates the first robot coordinate system with the imaging unit coordinate system of the imaging unit by moving the imaging unit. Accordingly, the control device 30 can operate the first robot with high accuracy based on the first image and the first robot coordinate system.

In addition, the control device 30 correlates the second robot coordinate system with the imaging unit coordinate system by fixing the imaging unit and moving the target object by means of the second robot. Accordingly, the control device 30 can operate the second robot with high accuracy based on the second image and the second robot coordinate system.

Hereinbefore, although the embodiments of the invention have been described in detail with reference to the drawings, specific configurations are not limited to the embodiments. Modifications, substitutions, and omissions may be made without departing from the spirit of the inventions.

In addition, a program for realizing a function of any configuration unit in the aforementioned device (for example, the control device (robot control device) 30) may be recorded in a recording medium which can be read by a computer, and the program may be executed by a computer system reading the program. Herein the “computer system” refers to an operating system (OS) or hardware including a peripheral device. In addition, the “recording medium which can be read by a computer” refers to a portable medium including a flexible disk, a magneto-optical disk, a ROM, a compact disk (CD)-ROM and a memory device including a hard disk mounted in the computer system. The “recording medium which can be read by a computer” further refers to a recording medium that maintains a program for a certain amount of time, such as a volatile memory (RAM) inside the computer system which becomes a server or a client in a case where the program is transmitted via a network, including the Internet, or a communication circuit including a telephone line.

In addition, the program may be transmitted to other computer systems from the computer system which stores the program in the memory device or the like via a transmission medium, or via a carrier wave within the transmission medium. Herein, the “transmission medium” which transmits the program refers to a medium having a function of transmitting information, such as a network (communication network) including the Internet or a communication circuit (communication line) including a telephone line.

In addition, the program may be a program for realizing apart of the aforementioned function. Furthermore, the program may be a program that can realize the aforementioned function in combination with a program already recorded in the computer system, in other words, a differential file (differential program).

The entire disclosures of Japanese Patent Application Nos. 2015-255908, filed Dec. 28, 2015; 2015-255909, filed Dec. 28, 2015 and 2015-255910, filed Dec. 28, 2015 are expressly incorporated by reference herein.

What is claimed is:

1. A robot that moves a first target object in a second direction different from a first direction based on an image captured by an imaging device from a time when the imaging device images the first target object at a first position until a time when the first target object reaches a second position which is in the same first direction as the first position.

2. The robot according to claim 1,
wherein the first target object is moved by a movement unit that is capable of moving the first target object in the first direction and the second direction.

3. The robot according to claim 2,
wherein the movement unit includes a first arm which is supported by a support base and is capable of rotating about a first axis, a second arm which is supported by the first arm and is capable of rotating about a second axis, and an operating shaft which is supported by the second arm and is capable of moving in the first direction and rotating about a third axis.

4. The robot according to claim 3,
wherein an angle of rotation of the operating shaft about the third axis at the time of imaging is made the same as an angle of rotation of the operating shaft about the third axis at the time of reaching.

5. The robot according to claim 1,
wherein the first target object is brought into contact with a second target object at the second position.

6. The robot according to claim 5,
wherein the first target object is fitted to the second target object at the second position.

7. A robot control device that controls the robot according to claim 1.

8. A robot control device that controls the robot according to claim 2.

9. A robot control device that controls the robot according to claim 3.

10. A robot control device that controls the robot according to claim 4.

11. A robot control device that controls the robot according to claim 5.

12. A robot control device that controls the robot according to claim 6.

13. A robot system comprising:
the robot according to claim 1;
a robot control device that controls the robot; and
the imaging device.

14. A robot system comprising:
the robot according to claim 2;
a robot control device that controls the robot; and
the imaging device.

15. A robot system comprising:
the robot according to claim 3;
a robot control device that controls the robot; and
the imaging device.

16. A robot system comprising:
the robot according to claim 4;
a robot control device that controls the robot; and
the imaging device.

17. A robot system comprising:
the robot according to claim 5;
a robot control device that controls the robot; and
the imaging device.

18. A robot system comprising:
the robot according to claim 6;
a robot control device that controls the robot; and
the imaging device.
